(19) United States
(12) Patent Application Publication
(10) Pub. No.: US 2004/0126691 A1
(43) Pub. Date: Jul. 1, 2004

(54) Toner for developing electrostatic latent image and image-forming method

(75) Inventors: Chikara Tsutsui, Nishinomiya-shi (JP); Masahiro Anno, Tokyo (JP); Masahide Inoue, Kitakatsuragi-gun (JP); Katsunori Kurose, Amagasaki-shi (JP)

Correspondence Address: BURNS DOANE SWECKER & MATHIS L L P, POST OFFICE BOX 1404, ALEXANDRIA, VA, 22313-1404, US

(73) Assignee: KONICA MINOLTA BUSINESS TECHNOLOGIES, INC.

(21) Appl. No.: 10/706,998

(22) Filed: Nov. 14, 2003

(30) Foreign Application Priority Data
Nov. 15, 2002 (JP) 2002-332035

(51) Int. Cl. G03G 9/08

(52) U.S. Cl. 430/108.4; 430/125; 430/110.3; 430/110.4; 430/111.4

(57) ABSTRACT

A toner for developing electrostatic latent images, having a specified volume-average particle size, an average degree of roundness, a standard deviation of the degree of roundness and surface properties D/d₅₀ wherein a specified amount of fatty acid metal salt that has a specified volume-average particle size is externally added, and an image-forming method using such a toner.

This application is based on application(s) No.2002-332035 filed in Japan, the contents of which are hereby incorporated by reference.

### BACKGROUND OF THE INVENTION

1. Field of the Invention

The present invention relates to a toner for use in an electrophotographic process, an electrostatic printing process and the like, and an image-forming method using such a toner.

2. Description of the Related Art

In recent years, in order to form images having high image quality and also to improve a transferring property of the formed images, various techniques for making the particle size of a toner smaller and for globurizing the toner particle have been developed. With respect to the globurizing method, a method for preparing globular toner by using a suspension polymerization method and an emulsion polymerization method in a wet system has been proposed (see Patent Document 1), and a technique for globularizing toner particles by thermally treating pulverized toner (see Patent Documents 2 and 3) has also been proposed.

However, the reduced particle size and globularized toner cause more residual toner escaped through a gap in the vicinity of edge portions of a cleaning blade at a nip section between the cleaning blade and the surface of a photosensitive member, and tend to result in an insufficient cleaning operation. For this reason, the press-contact force of the cleaning blade to the photosensitive member needs to be increased so as to prevent the residual toner escape; however, when the press contact force is increased, a shearing force is locally applied to the cleaning blade contacting the photosensitive member, with the result that chipping (chipped portions) tends to occur in the cleaning blade. The photosensitive member is subjected to abrasion.

In order to solve the above-mentioned problems, another technique for externally adding fatty-acid metal salt particles to a toner has been proposed. For example, an electrostatic latent image developing toner (Patent Document 4) has been proposed in which: to a toner base particle containing a binder resin and a colorant are externally added as a first component, 0.05 to 2.00% by weight of hydrophobic silica or hydrophobic titania having a number-average particle size of 5 to 40 nm; as a second component, 0.05 to 2.00% by weight of hydrophobic silica or hydrophobic titania having a number-average particle size of 20 to 160 nm (the number-average particle size of which is greater than the number-average particle size of the first component); as a third component, 0.4 to 3.5% by weight of inorganic particles which have a number-average particle size of 80 to 1200 nm, with a rate of content of particles having a particle size of not less than 1500 being set to not more than 20% by number (the number-average particle size of which is greater than the number-average particle size of the second component); and as a fourth component, 0.02 to 0.25% by weight of fatty-acid metal salt having a volume-average particle size of 1.5 to 12 μm, and a toner, which is constituted by a toner base material that is made from at least a binder resin and a colorant, and exhibits a negatively charging property, and an externally additive agent made from at least fatty-acid metal salt, is proposed (see Patent Document 5).

However, when the above-mentioned toner is used as a non-magnetic mono-component developing toner, the fatty-acid metal salt tends to adhere to a charge-applying member (regulating member), causing adverse effects to the charging performance and the subsequent reduction in the image density and fogging. The problem of deterioration in the charging performance becomes more serious when image-forming processes are continuously carried out under L/L environment (10° C., 15% RH) and H/H environment.

### SUMMARY OF THE INVENTION

The present invention is to provide a toner which is superior in cleaning property, chargeability, environmental stability and durability, and provides good images that are free from noise such as fogging, lines and unswept toner, for a long time, even in the case of toner particles having a globular shape with a small particle size, and an image-forming method using such a toner.

The present invention relates to a toner for developing electrostatic latent images and an image-forming method using thereof; the toner having:

a volume-average particle size of 3 to 7 μm,

an average degree of roundness of 0.960 to 0.995,

a standard deviation of the degree of roundness of not more than 0.04, and

surface properties D/d₅₀ that satisfy the following conditional expression,

wherein 0.001 to 0.1% by weight of fatty acid metal salt that has a volume-average particle size of 1.5 to 12 μm is externally added;

D/d₅₀≧0.40

in which b=6/(ρ·S), (ρ is a true density (g/cm³) of toner particles, S is a BET specific surface area (m²/g) of toner particles), and d₅₀ represents a weight-average particle size (μm) of the toner particles.

### BRIEF DESCRIPTION OF THE DRAWING

FIG. 1 is a schematic block diagram that shows a relationship between a photosensitive member and a cleaning blade for an image-forming method to which a non-magnetic mono-component developing toner of the present invention is suitably applied;

FIG. 2 is a schematic block diagram that shows one example of a full-color image-forming apparatus to which the toner of the present invention is suitably applied;

FIG. 3 is a schematic block diagram that shows one example of a full-color image-forming apparatus to which the toner of the present invention is suitably applied;

FIG. 4 is a schematic block diagram that shows a device for carrying out an instantaneous heating process to be applied to manufacturing processes for the toner of the present invention;

FIG. 5 is a schematic horizontal cross-sectional view that shows a sample discharging chamber in the device shown in FIG. 4; and

FIG. 6(A) is a schematic block diagram that shows one example of a reaction device to be applied to manufacturing processes for the toner of the present invention, and

FIG. 6(B) is a schematic diagram that shows one example of a generally-used reaction device.

### DETAILED DESCRIPTION OF THE INVENTION

The present invention provides a toner toner for developing electrostatic latent images, having:

a volume-average particle size of 3 to 7 μm,

an average degree of roundness of 0.960 to 0.995,

a standard deviation of the degree of roundness of not more than 0.04, and

surface properties D/d₅₀ that satisfy the following conditional expression,

wherein 0.001 to 0.1% by weight of fatty acid metal salt that has a volume-average particle size of 1.5 to 12 μm is externally added;

D/d₅₀≧0.40

in which D=6/(ρ·S), (ρ is a true density (g/cm³) of toner particles, S is a BET specific surface area (m²/g) of toner particles), and d₅₀ represents a weight-average particle size (μm) of the toner particles.

The present invention also provides an image-forming method, in which an electrostatic latent image formed on the surface of an electrostatic latent image supporting member is developed by a toner to form an image; and after the image has been transferred onto a transferring member, the residual toner on the electrostatic latent image supporting member is cleaned by using a cleaning blade, being characterized in that:

the toner has a volume-average particle size of 3 to 7 μm, an average degree of roundness of 0.960 to 0.995,

a standard deviation of the degree of roundness of not more than 0.04, and surface properties D/d₅₀ that satisfy the following conditional expression;

and that 0.001 to 0.1% by weight of fatty acid metal salt that has a volume-average particle size of 1.5 to 12 μm is externally added:

D/d₅₀≧0.40

in which D=6/(ρ·S) (ρ is a true density (g/cm³) of toner particles, S is a BET specific surface area (m²/g) of toner particles), and d₅₀ represents a weight-average particle size (μm) of the toner particles.

(Image-Forming Method)

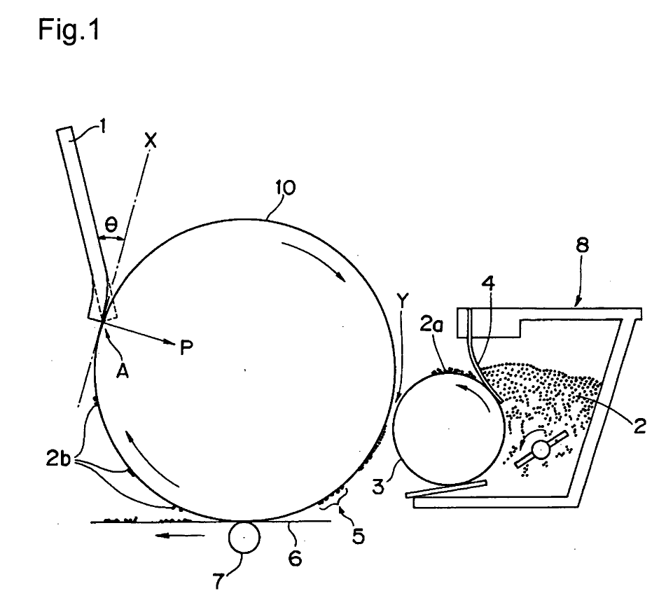

First the following description will discuss an image-forming method to which the toner of the present invention is suitably applied. In this image-forming method, an electrostatic latent image, formed on the surface of an electrostatic latent image supporting member (hereinafter, referred to as photosensitive member), is developed by a toner to form an image on the photosensitive member, and after the image has been transferred onto a copying material, residual toner on the photosensitive member is cleaned by a cleaning blade. Referring to FIG. 1, the following description explains the method. FIG. 1 is a schematic drawing that shows a relationship among a photosensitive member 10, a cleaning blade 1 and a developing device 8, and explains an image-forming method to which the non-magnetic mono-component developing toner is applied.

In this non-magnetic mono-component developing method, when non-magnetic mono-component developing toner 2 is transported by a toner supporting member 3 to a developing area Y (a gap between the toner supporting member 3 and the photosensitive member 10) that faces the photosensitive member 10, a regulating member 4, which is placed in contact with the surface of the toner supporting member 3, regulates the amount of the toner in the course of the transporting process to the developing area Y, and also charges the toner. The resulting toner 2a thus regulated and charged is transported to the developing area Y so that a latent image formed on the surface of the photosensitive member 10 is developed to form an image 5 on the photosensitive member 10.

The image 5, formed on the photosensitive member, is transferred onto a transfer material 6 by a transferring means such as a transferring roller 7. The transfer material 6 may be a recording material or an intermediate transferring member that temporarily holds images having one or more colors. When the intermediate transferring member is used, the image transferred onto the intermediate transferring member is finally copied onto a recording material.

After the image has been transferred onto the transfer material 6 from the photosensitive member 10, residual toner 2b on the photosensitive member is cleaned by a cleaning blade 1. In the cleaning process, as shown in FIG. 1, the cleaning blade 1 the tip portion of which is made in press-contact with the photosensitive member 10 is allowed to scrape the residual toner 2b off the photosensitive member 10 so as to be removed. In the present invention, even when the toner particles have a globular shape with a comparatively small particle size, it is possible to effectively prevent escape of the residual toner (unswept toner) between the cleaning blade 1 and the photosensitive member 10, while preventing chipping in the cleaning blade and abrasion of the photosensitive member. More specifically, the cleaning blade 1 is placed on the downstream side of a contact point A between the cleaning blade 1 and the photosensitive member 10 in the rotation direction of the photosensitive member 10, and secured thereto with a press-contact angle (θ) of 10 to 20° and a press-contact force (P) of 20 to 50 N/m, preferably 20 to 45 N/m with respect to the photosensitive member 10.

In the case of θ exceeding 20° or P exceeding 50 N/m, the photosensitive member is subjected to much abrasion, causing a shortened service life of the photosensitive member. Chipping (chipped portions) occurs in the cleaning blade, causing noise as lines on an image. In the case of θ less than 10° or P less than 20 N/m, escape of residual toner tends to occur, causing noise on an image due to degradation in the cleaning property.

The press-contact angle (θ) represents an angle made by a tangent X and the cleaning blade 1 (indicated by a broken line) before deformation at a contact point A of the photosensitive member 10.

The press-contact force (P) represents a force that is exerted in the direction toward the center of the photosensitive member, and applied by the cleaning blade 1 to press the photosensitive member 10, when the cleaning blade 1 is pressed onto the photosensitive member 10.

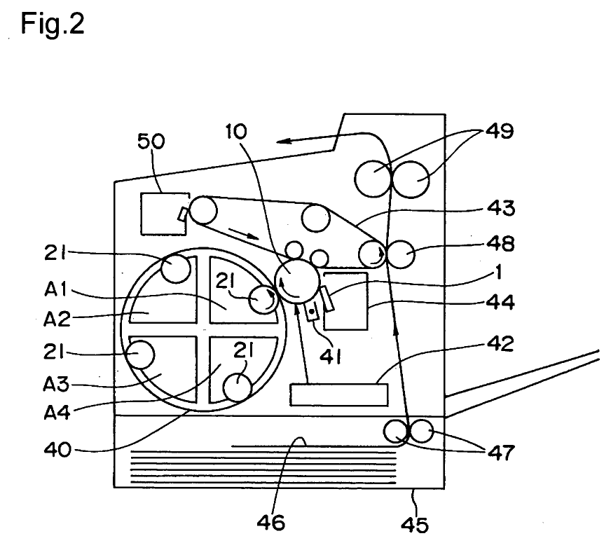

Referring to, for example, a full-color image-forming apparatus shown in FIG. 2, the following description will discuss the above-mentioned image-forming method more specifically. This full-color image-forming apparatus has a 4-cycle system which uses four developing devices A1 to A4 and one photosensitive member 10, and one cleaning device 44 is used in association with the single photosensitive member 1. In the cleaning device 44, the cleaning blade 1 is arranged so that the press-contact angle (θ) and the press-contact force (P) are set in the above-mentioned ranges with respect to the photosensitive member 10. An intermediate transferring member (intermediate transferring belt) is used as the transferring material so that the image transferred onto the intermediate transferring belt is copied onto a recording material (sheet-shape recording paper).

The full-color image-forming apparatus, shown in FIG. 2, houses toners having different colors, such as yellow, magenta, cyan and black, in four developing devices A1 to A4. These four developing devices A1 to A4 are held in holders 40 that are allowed to rotate, and the positions of the respective developing devices A1 to A4 are changed by the holders 40 so that the toner supporting member 21 in each of the developing devices A1 to A4 is successively directed to each of positions at which it is allowed to face the photosensitive member 10. In the respective developing areas at which the toner supporting member 21 faces the photosensitive member 10, the toner supporting member 21 and the photosensitive member 10 are allowed to shift upward from below.

In the case when a full-color image is formed by using this full-color image-forming apparatus, for example, first, the toner supporting member 21 in the first developing device A1 housing the yellow toner is positioned to face the photosensitive member 10, and the photosensitive member 10 is rotated so that the surface of the photosensitive member 10 is uniformly charged by a charging device 41. The photosensitive member 10, thus charged, is subjected to exposure in accordance with an image signal by an exposing device 42 so that an electrostatic latent image is formed on the surface of the photosensitive member 10.

In a developing area at which the photosensitive member 10 bearing the electrostatic latent image formed thereon and the toner supporting member 21 in the first developing device A are aligned face to face with each other, the toner supporting member 21 and the photosensitive member 10 are respectively moved upward from below. At this time, the yellow toner is supplied to the electrostatic latent image portion formed on the photosensitive member 10 from the toner supporting member 21 so that a yellow toner image corresponding to the electrostatic latent image is formed on the photosensitive member 10.

Then, the yellow toner image, thus formed on the photosensitive member 10, is transferred onto an intermediate transferring member 43 that has an endless belt form passed over the photosensitive member 10. On the other hand, yellow toner remaining on the photosensitive member 10 after the transferring process is removed from the photosensitive member 10 by the cleaning blade 1 of the cleaning device 44.

The holders 40 are rotated so that the toner supporting member 21 in the second developing device A2 housing toner of magenta color is placed at a position so as to face the photosensitive member 10. In the same manner as the first developing device A1, a magenta-color toner image is formed on the surface of the photosensitive member 10, and this magenta-color toner image is transferred onto the intermediate transferring member 43 having the yellow toner image formed thereon. Magenta toner remaining on the photosensitive member 10 after the transferring process is removed from the photosensitive member 10 by the cleaning blade 1 of the cleaning device 44.

The same operations as described above are carried out so that a cyan-color toner image is formed on the surface of the photosensitive member 10 by the third developing device A3 housing toner of cyan color, and this cyan-color toner image is transferred onto the above-mentioned intermediate transferring member 43. A black toner image is formed on the surface of the photosensitive member 10 by the fourth developing device A4 housing black toner, and this black toner image is transferred onto the above-mentioned intermediate transferring member 43. In this manner, the respective yellow, magenta, cyan and black color toner images are transferred onto the intermediate transferring member 43 so that a full-color toner image is formed thereon.

A recording sheet 46 is taken from a paper cassette 45 placed at a lower portion of the full-color image-forming apparatus, and directed by a feed roller 47 to a portion at which the intermediate transferring member 43 and the transferring roller 48 are aligned face to face with each other, and the full-color toner image, formed on the intermediate transferring member 43, is transferred on this recording sheet 46. The full-color toner image, thus transferred onto the recording sheet 46, is fixed on the recording sheet 46 by a fixing device 49, and the sheet is discharged. Toner remaining on the intermediate transferring member 43 without being transferred is removed from the intermediate transferring member 43 by a cleaning device 50 for an intermediate transferring member.

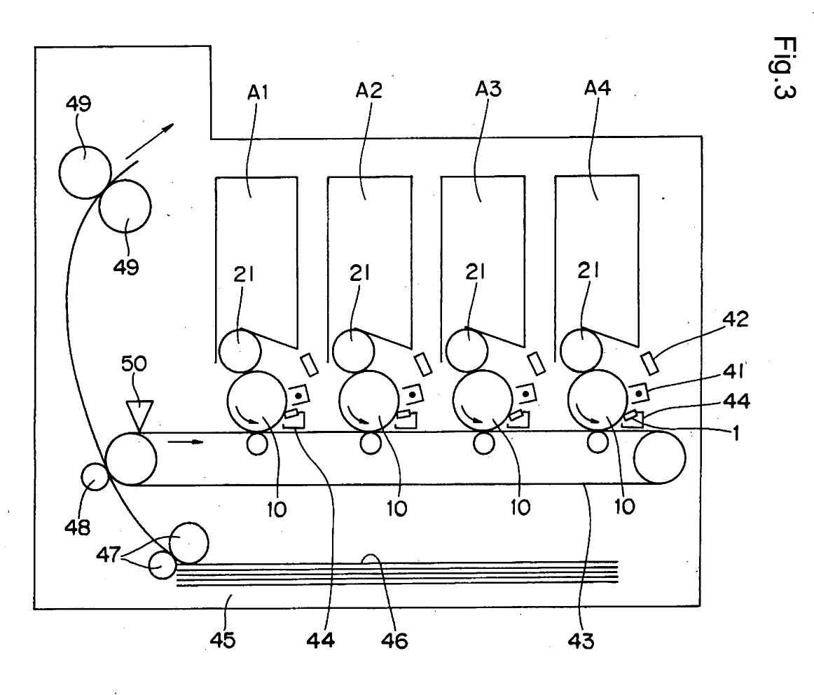

Referring to a full-color image-forming apparatus shown in FIG. 3, the following description will discuss another specific example of the above-mentioned image-forming method. This full-color image-forming apparatus has a tandem system which uses four developing devices A1 to A4 and four photosensitive members 10, and four cleaning devices 44 are used in association with the four photosensitive members. In each of the cleaning devices 44, the cleaning blade 1 is arranged so that the press-contact angle (θ) and the press-contact force (P) are set in the above-mentioned ranges with respect to each photosensitive member 10. An intermediate transferring member (intermediate transferring belt) is used as the transferring material so that the image transferred onto the intermediate transferring belt is copied onto a recording material (sheet-shape recording paper).

The full-color image-forming apparatus, shown in FIG. 3, houses toners having different colors, such as yellow, magenta, cyan and black, in four developing devices A1 to A4. These four developing devices A1 to A4 are arranged in parallel with each other in the full-color image-forming apparatus, and each of the photosensitive members 10 is placed in a manner so as to face the toner supporting member 21 of each of the developing devices A1 to A4. An intermediate transferring member 43 having an endless belt form is placed at a position opposite to the developing devices A1 to A4 on the basis of each photosensitive member 10, and this intermediate transferring member 43 is made in contact with each of the photosensitive members 10.

In the case when a full-color image is formed by using this full-color image-forming apparatus, for example, first, the photosensitive member 10 facing the toner supporting member 21 in the first developing device A1 housing the yellow toner is rotated so that the surface of the photosensitive member 10 is uniformly charged by a charging device 41. The photosensitive member 10, thus charged, is subjected to exposure in accordance with an image signal by an exposing device 42 so that an electrostatic latent image is formed on the surface of the photosensitive member 10. In a developing area at which the photosensitive member 10 bearing the electrostatic latent image formed thereon and the toner supporting member 21 in the first developing device A are aligned face to face with each other, the toner supporting member 21 supplies yellow toner to an electrostatic latent image portion formed on the photosensitive member 10 so that a yellow toner image corresponding to the electrostatic latent image is formed on the photosensitive member 10. Then, the yellow toner image, formed on the photosensitive member 10 in this manner, is transferred onto the above-mentioned intermediate transferring member 43. On the other hand, yellow toner remaining on the photosensitive member 10 after the transferring process is removed from the photosensitive member 10 by the cleaning blade 1 of the cleaning device 44.

In the second to fourth developing devices A2 to A4 also, in the same manner as the first developing device A1, magenta-color, cyan-color and black toner images are successively transferred (formed) on the intermediate transferring member 43 so that a full-color toner image is formed on the intermediate transferring member 43. Thereafter, in the same manner as the above-mentioned 4-cycle-type full-color image-forming apparatus, the full-color toner image is copied onto a recording sheet 46, and the full-color toner image, transferred onto the recording sheet 46, is fixed on the recording sheet 46 by a fixing device 49, and the recording sheet 46 is then discharged.

(Toner)

The toner of the present invention is formed by externally adding at least fatty-acid metal salt particles to specific toner particles so as to be mixed therein. In the present specification, the expression, “externally added”, refers to the fact that the particles are added to the preliminarily prepared toner particle so as to allow them to exist on the peripheral portion of the toner particle.

In the present invention, the fatty-acid metal salt (SCP) has a volume-average-particle size of 1.5 to 12 μm, preferably 2 to 10 μm, preferably 3 to 7 μm, and is externally added to the toner particles at a comparatively small rate, that is, a rate of 0.001 to 0.1% by weight, preferably 0.001 to 0.08% by weight, more preferably 0.005 to 0.015% by weight. In the present invention, such addition conditions of the fatty-acid metal salt are adopted in combination with the above-mentioned cleaning conditions and toner-particle conditions that will be described later so that it is possible to obtain a superior lubricating function of the fatty-acid metal salt. In other words, in the present invention, when used under the above-mentioned addition conditions and the aforementioned cleaning conditions as well as the toner-particle conditions that will be described later, the fatty-acid metal salt of the present invention is allowed to effectively provide a lubricating coat film on the surface of the photosensitive member; thus, it becomes possible to prevent chipping in the cleaning blade and abrasion in the photosensitive member and also to achieve a superior cleaning property to prevent image noise such as unswept toner, while maintaining superior chargeability in the toner. For example, in the case when the toner particle conditions and/or cleaning conditions are not set in the predetermined ranges, the above-mentioned reduced amount of external addition of the fatty-acid metal salt fails to provide sufficient chargeability, and also fails to prevent chipping in the cleaning blade and abrasion of the photosensitive member, resulting in noise on an image due to unswept toner. At this time, when the amount of external addition of the fatty-acid metal salt is increased in an attempt to achieve both of the prevention of abrasion and the like of the photosensitive member and the superior cleaning property, the chargeability further deteriorates, resulting in a reduction in the image density and fogging on an image.

When the added amount of the fatty-acid metal salt is too small, the fatty-acid metal salt fails to exert a sufficient lubricating function on the photosensitive member, resulting in too much abrasion in the photosensitive member and chipping in the cleaning blade. When the added amount thereof is too great, the chargeability tends to deteriorate, resulting in a reduction in the image density and fogging on the photosensitive member. These problems become more serious when image-forming processes are continuously carried out under L/L environment (10° C., 15% RH) and H/H environment.

When the volume-average particle size of the fatty-acid metal salt is too small, the fatty-acid metal salt is transferred onto paper together with the toner particles, with the result that the amount of the fatty-acid metal salt functioning on the photosensitive member is greatly reduced, causing too much abrasion in the photosensitive member and chipping in the cleaning blade. Noise appears on an image due to unswept toner. When the volume-average particle size of the fatty-acid metal salt is too big, the number of the fatty-acid metal salt particles is reduced, with the result that the fatty-acid metal salt fails to exert a sufficient lubricating function on the photosensitive member, causing chipping in the cleaning blade and noise on an image due to unswept toner.

In the present invention, the kind of the fatty-acid metal salt is not particularly limited as long as it has a particle size as described above and is used at the above-mentioned rate. For example, a salt between fatty acid represented by the following formula and metal is proposed:

CₙH₂ₙ₊₁COOH (in the formula, n indicates any number of 12 to 18). With respect to the metal, not particularly limited as long as it forms a salt with the above-mentioned fatty acid, examples thereof include: calcium, zinc, magnesium, aluminum and lithium. Preferably, from the viewpoints of costs, safety and lubricating function, calcium is used.

In an attempt to further improve the heat resistance and lubricating function, the fatty-acid metal salt preferably has a melting point of 100 to 150° C., and preferable examples thereof include calcium stearate, zinc stearate and magnesium stearate. The melting point of not more than 100° C. tends to cause degradation in the toner heat resistance, resulting in aggregation during storage under a high-temperature environment. The melting point of not less than 150° C. tends to cause a reduction in the lubricating function. With respect to calcium stearate, that manufactured through a direct method and that manufactured through a double decomposition method have been known; and the calcium stearate, obtained through the direct method which causes less impurities, is pulverized and grain-adjusted, and preferably used.

The toner particles to which the above-mentioned fatty-acid metal salt is externally added are designed to have a volume-average particle size of 3 to 7 μm and an average degree of roundness of 0.960 to 0.995, preferably 0.970 to 0.990, with the standard deviation of the degree of roundness being set to not more than 0.040, preferably 0.01 to 0.035, and the surface property thereof is allowed to satisfy the following conditions:

D/d=d₅₀≧0.40,

Preferably,

0.8≧D/d₅₀≧0.40,

Preferably,

0.7≧D/d₅₀≧0.45,

(in the expression, D=6/(ρ·S), ρ is a true density (g/cm³) of toner particles, S is a BET specific surface area (m²/g) of toner particles, and d₅₀ represents a weight-average particle size (μm) of the toner particles.)

When the volume-average particle size is too small, it becomes difficult to handle toner particles. When the volume-average particle size is too great, it is not possible to obtain a desired chargeability, causing noise such as fogging.

When the average degree of roundness is too small, it is not possible to obtain a desired chargeability, causing noise. When the average degree of roundness is too great, it becomes difficult to carry out manufacturing processes, and the resulting toner particles from such manufacturing processes cause many toner particles escaped through a gap between the cleaning blade and the photosensitive member during photosensitive member cleaning processes, resulting in noise due to unswept toner particles.

In the case when the standard deviation of the average degree of roundness is too great, since the shape of the toner particles becomes irregular, it is not possible to obtain a desired chargeability, resulting in noise.

In the case when D/d₅₀, which indicates the surface shape property, is too small, since many thin pores exist on the surface and inside of each toner particle, the toner is subjected to cracking when mixed and stirred in the developing device, resulting in toner fine powder and the resulting toner adhered onto the blade as well as degradation in the chargeability. The fluidizing agent tends to be embedded into the toner particles. Consequently, the chargeability is lowered, and fogging occurs on an image. Image losses tend to occur on an image.

In the present invention, with respect to the volume-average particle size, values measured by “Coulter Multisizer II (made by Beckman Coulter, Inc.)” are used; however, the measuring device is not limited by this, and any device may be used as long as the measurements are carried out in the same measuring principle and method.

The average degree of roundness is the average value of values calculated by the following equation:

$$Average degree of roundness = \frac{Peripheral length of a circle equal to projection area of a particle}{Peripheral length of a particle projection image}$$

Since the average degree of roundness is obtained by “Peripheral length of a circle equal to projection area of a particle” and “Peripheral length of a particle projection image”, the resulting value provides an index that correctly reflects the recessed and protruding conditions of the surfaces of particles. In other words, the closer to 1 the value becomes, the closer to the true globe the shape becomes. Since the average degree of roundness is a value obtained as an average value of toner particles (3000 toner particles), the reliability of the degree of roundness of the present invention is very high. In the present invention, with respect to the average degree of roundness, “Peripheral length of a circle equal to projection area of a particle” and “Peripheral length of a particle projection image” are represented by values obtained through measurements carried out by a flow-type particle image analyzer (FPIA-1,000 or FPIA-2,000; made by TOA MEDICAL ELECTRONICS CO., LTD.) in an aqueous system. However, the average degree of roundness is not necessarily measured by the above-mentioned apparatus, and any apparatus may be used, as long as it is capable of carrying out the measurements based upon the above-mentioned equation in principle.

The standard deviation of the degree of roundness indicates the standard deviation in the distribution of the degree of roundness, and this value is obtained together with the average degree of roundness at the same time by the above-mentioned flow-type particle image analyzer. The smaller the value, the more uniform the toner particle shape.

This D/d₅₀, which indicates a surface shape characteristic, is an index indicating whether or not thin pores exist on the surface or the inside of the toner particle, and when toner particles satisfy the above-mentioned value, those toner particles are free from the problems that the toner particle has a crack centered on the thin pore, that silica or the like, which is a fluidizing agent to be added as an external additive agent, is embedded in recessed portions and that protruding portions are pulverized to generate fine powder. D represents a converted particle size (pm) from the BET specific surface area obtained when it is supposed that the toner shape is a globe, and is represented by 6/(ρ·S); ρ is a true density (g/cm³) of the toner particles; S is a BET specific surface area (m²/g) of the toner particles; and d₅₀ is a particle size corresponding to 50% of the relative weight distribution classified by particle sizes of the toner particles (weight-average particle size) (μm).

With respect to the true density (ρ), values measured by an air comparison pycnometer (made by Beckman Instruments Inc.) are used; however, the measuring device is not limited by this, and any device may be used as long as the measurements are carried out based upon the same measuring principle and method.

With respect to the BET specific surface area (S), values measured by “a Micromeritics FlowSorb II 2300” (made by Micromeritics GmbH) are used; however, the measuring device is not limited by this, and any device may be used as long as the measurements are carried out based upon the same measuring principle and method.

With respect to the weight-average particle size (d₅₀), values measured by “a Coulter Multisizer” (made by Coulter Counter, Inc.)” are used; however, the measuring device is not limited by this, and any device may be used as long as the measurements are carried out based upon the same measuring principle and method.

The toner particles are composed of at least a binder resin and a colorant, and may further contain a wax and a charge-control agent, if necessary.

With respect to the binder resin, thermoplastic resins, used for toner-constituting binder resins, are adopted. In the present invention, those resins having a glass transition temperature of 50 to 75° C., a softening point of 80 to 160° C., a number-average molecular weight of 1,000 to 30,000 and a ratio of weight-average molecular weight/number-average molecular weight of 2 to 100, are preferably used. In particular, in the case of preparation for full-color toner (including black toner), it is preferable to use resins having a glass transition point of 50 to 75° C., a softening point of 80 to 120° C., a number-average molecular weight of 2,000 to 30,000 and a ratio of weight-average molecular weight/number-average molecular weight of 2 to 20.

In order to improve the fixing property for oil-less fixing toners as well as improving the anti-offset property, or in order to control the gloss-applying property for images in full-color toners requiring a light-transmitting property, it is preferable to use two kinds of binder resins having different softening points as its binder resins. More specifically, with respect to the oil-less fixing toners, the first resin having a softening point of 80 to 125° C. is used so as to improve the fixing property, and the second resin having a softening point of 125 to 160° C. is used so as to improve the anti-offset property. In this case, when the softening point of the first resin is lower than 80° C., the anti-offset property is lowered and the reproducibility of dots is lowered; and the softening point exceeding 125° C. fails to provide sufficient effects for improving the fixing property. When the softening point of the second is lower than 125° C., the effects for improving the anti-offset property become insufficient, and the softening point exceeding 160° C. reduces the fixing property. For this reason, the softening point of the first resin is preferably set from 95 to 120° C., and preferably 100 to 115° C., and the softening point of the second resin is more preferably set from 130 to 160° C., and preferably 135 to 155° C. The glass transition points of the first and second resins are preferably set from 50 to 75° C., and preferably from 55 to 70° C. This is because, when the glass transition point is too low, the heat resistance of toner becomes insufficient and when it is too high, the pulverizing performance during manufacturing processes of the toner particles using a pulverizing method is lowered, resulting in a low production efficiency. The softening point of the second resin is preferably set higher than the softening point of the first resin by not less than 10° C., preferably not less than 15° C.

The ratio of weights of the first resin and the second resin is set at 8:2 to 2:8, and preferably 6:4 to 3:7. The application of the first resin and the second resin in such a range provides a superior dot-reproducibility with less toner expansion due to crushing at the time of fixing and a superior low-temperature fixing property; this makes it possible to ensure a good fixing property both in high-speed and low-speed image-forming apparatuses. It is possible to ensure a superior dot-reproducibility even in double-sided image-forming processes (in which two passages are made through the fixing device). The ratio of the first resin less than the above-mentioned range makes the low-temperature fixing property insufficient, and fails to ensure a wide range of fixing property. The ratio of the second resin less than the above-mentioned range tends to cause degradation in the anti-offset property and cause toner expansion due to crushing at the time of fixing, resulting in degradation in the dot-reproducibility.

In the full-color process requiring a light-transmitting property, resins of a sharp-melt type, which have a sharp molecular weight distribution, are conventionally used; and the application of resins of this type makes it possible to reproduce pictorial images with gloss. However, in recent years, in color copying normally used in offices, there are increasing demands for images with less degree of gloss. In order to meet such demands, for example, the molecular weight distribution of the resin is widened to the high-molecule side. One of the specific methods for this is to use two or more kinds of resins having different molecular weights in a combined manner; and when the resin thus obtained finally through the combination has a glass transition point of 50 to 75° C., a softening point of 80 to 120° C., a number-average molecular weight of 2,500 to 30,000 and a ratio of weight-average molecular weight/number-average molecular weight in the range of 2 to 20, it is preferably adopted. In the case of application with less degree of gloss, the value of the ratio of weight-average molecular weight/number-average molecular weight is set to not less than 4 so that the melt-viscosity curve is tilted; thus, it becomes possible to expand the gloss-degree controlling range with respect to the fixing temperature.

With respect to the kinds of the binder resin, for example, polyester-based resin, styrene-based resin and the like are used.

With respect to the polyester-based resin, a polyester resin, prepared by condensation-polymerizing a polyhydroxy alcohol component and a polycarboxylic acid component, can be applied.

Among polyhydroxy alcohol components, examples of dihydric alcohol components include: bisphenol A alkylene oxide adducts, such as polyoxypropylene(2,2)-2,2-bis(4-hydroxyphenyl)propane, polyoxypropylene(3,3)-2,2-bis(4-hydroxyphenyl)propane, polyoxypropylene(6)-2,2-bis(4-hydroxyphenyl)propane and polyoxyethylene(2,0)-2,2-bis(4-hydroxyphenyl)propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polytetramethylene glycol, bisphenol A and hydrogenated bisphenol A.

Examples of trihydric or higher alcohol components include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Among polycarboxylic acid components, examples of dihydric carboxylic acid components include: maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, isooctenyl succinic acid, n-octyl succinic acid, isooctyl succinic acid, and anhydrides or lower alkyl esters of these acids.

Examples of trihydric or higher carboxylic acid components include: 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, empol trimer acid, anhydrides or low alkyl esters of these acids.

In the present invention, with respect to the polyester-based resin, a resin obtained by the following processes is preferably used: that is, a mixture of a material monomer for a polyester resin, a material monomer for a vinyl-based resin and a monomer that reacts with both of the material monomers for the resins is used and a polycondensing reaction for obtaining the polyester resin and a radical polymerization reaction for obtaining a styrene-based resin are carried out in parallel with each other to obtain the resin in the same container. The monomer that reacts with both of the material monomers for the resins refers to a monomer which is applicable to both of the polycondensing reaction and radical polymerization reaction. In other words, this monomer has a vinyl group that undergoes a radical polymerization reaction with a carboxy group that is allowed to undergo a polycondensing reaction, and examples thereof include fumaric acid, maleic acid, acrylic acid and methacrylic acid.

With respect to the material monomer for the polyester resin, examples thereof include the above-mentioned polyhydroxy alcohol components and polycarboxylic acid components.

Examples of the raw-material monomer for the vinyl-based resin (vinyl-based monomer) that is capable of forming a polyester-based resin include: styrene or styrene derivatives, such as styrene, o-methylstyrene, m-methylstyrene, p-methylstyrene, α-methylstyrene, p-ethylstyrene, 2,4-dimethylstyrene, p-tert-butylstyrene and p-chlorostyrene; ethylene-based unsaturated monoolefins, such as ethylene, propylene, butylene and isobutylene; methacrylic acid alkyl esters, such as methylmethacrylate, n-propylmethacrylate, isopropylmethacrylate, n-butylmethacrylate, isobutylmethacrylate, t-butylmethacrylate, n-pentylmethacrylate, isopentylmethacrylate, neopentylmethacrylate, 3-(methyl)butylmethacrylate, hexylmethacrylate, octylmethacrylate, nonylmethacrylate, decylmethacrylate, undecylmethacrylate and dodecylmethacrylate; acrylic acid alkyl esters, such as methylacrylate, n-propylacrylate, isopropylacrylate, n-butylacrylate, isobutylacrylate, t-butylacrylate, n-pentylacrylate, isopentylacrylate, neopentylacrylate, 3-(methyl)butylacrylate, hexylacrylate, octylacrylate, nonylacrylate, decylacrylate, undecylacrylate, and dodecylacrylate; unsaturated carboxylic acids, such as acrylic acid, methacrylic acid, itaconic acid and maleic acid; acrylonitrile, maleic acid ester, itaconic acid ester, vinyl chloride, vinylacetate, vinylbenzoate, vinylmethylethylketone, vinylhexylketone, vinylmethylether, vinylethylether, and vinylisobutylether.

With respect to polymerization initiators to be used upon polymerizing the material monomers for the vinyl-based resin, those of oil-soluble type and those of water-soluble type are proposed. Examples of the oil-soluble polymerization initiators include: azo-based or diazo-based polymerization initiators such as 2,2′-azobis(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile and azobisisobutyronitrile; and a peroxide polymerization initiator and a polymer initiator having a peroxide on its side chain, such as benzoyl peroxide, methylethylketone peroxide, diisopropylperoxycarbonate, cumene hydroperoxide, t-butylhydroperoxide, di-t-butylperoxide, dicumyl peroxide, 2,4-dichlorobenzoyl peroxide, lauroyl peroxide, 2,2-bis-(4,4-t-butylperoxy cyclohexyl) propane and tris-(t-butylperoxy) triazine. With respect to the water-soluble polymerization initiators, examples thereof include persulfates such as potassium persulfate and ammonium persulfate, azobisamino dipropane acetate, azobiscyano valeric acid and its salt and hydrogen peroxide.

With respect to the vinyl-based resin to be used as the binder resin, vinyl-based resins made from the above-mentioned vinyl-based monomers may be used. Among the vinyl-based resins, a styrene-acrylic resin, obtained by copolymerizing styrene or a styrene derivative, a methacrylic acid alkyl ester and/or an acrylic acid alkyl ester and unsaturated carboxylic acid, is preferably used.

Besides these, epoxy resins are preferably used particularly in full-color toners. Examples of epoxy resins preferably used in the present invention include polycondensated products between bisphenol A and epichlorohydrin. For example, Epomic R362, R364, R365, R367, R369 (made by Mitsui Chemicals Inc.), Epotot YD-011, YD-012, YD-014, YD-904, YD-017 (made by Touto Kasei) and Epi Coat 1002, 1004, 1007 (made by Shell Oil Co.) are commercially available.

With respect to the binder resin, a polyester-based resin, which has the above-mentioned characteristics with an acid value of 2 to 50 KOHmg/g, preferably 3 to 30 KOHmg/g, is preferably used. By using the polyester-based resin having such an acid value, it is possible to improve the dispersing property of various pigments containing carbon black and charge-control agents, and also to provide a toner having a sufficient quantity of charge. The acid value less than 2 KOHmg/g reduces the above-mentioned effects. The acid value exceeding 50 KOHmg/g fails to stably maintain the quantity of charge in toner against environmental fluctuations, in particular, fluctuations in humidity.

Known pigments and dyes are used as colorants. Examples thereof include: carbon black, aniline blue, Chalcooil Blue, chrome yellow, ultramarine blue, DuPont Oil Red, quinoline yellow, methylene blue chloride, copper phthalocyanine, Malachite green oxalate, Lump Black, Rose Bengal, C.I. Pigment Red 48:1, C.I. Pigment Red 122, C.I. Pigment Red 57:1, C.I. Pigment Red 184, C.I. Pigment Yellow 97, C.I. Pigment Yellow 12, C.I. Pigment Yellow 17, C.I. Solvent Yellow 162, C.I. Pigment Yellow 180, C.I. Pigment Yellow 185, C.I. Pigment Blue 15:1, C.I. Pigment Blue 15:3, etc. With respect to the black toner, in addition to various carbon blacks, activated carbon and titanium black, one portion or the entire portion of the colorant may be replaced with a magnetic substance. Examples of such a magnetic substance include known magnetic fine particles such as ferrite, magnetite and iron. In an attempt to obtain an appropriate dispersion property upon manufacturing, the average particle size of the magnetic particles is preferably set to not more than 1 μm, preferably not more than 0.5 μm. The content of these colorants is normally set in a range of 0.5 to 10 parts by weight, preferably 0.5 to 8 parts by weight, more preferably 1 to 5 parts by weight, with respect to 100 parts by weight of the binder resin.

Examples of the wax include polyethylene wax, polypropylene wax, carnauba wax, rice wax, sazol wax, montan ester waxes, Fischer-Tropsch wax, etc. In the case of addition of a wax to the toner, the content is normally set in a range of 0.5 to 5 parts by weight to 100 parts by weight of the binder resin.

With respect to the charge-controlling agent to be added, examples thereof include metal-containing dyes such as a fluorine-based surfactant, a salicylic acid metal complex and an azo-based metal compound, a polymeric acid such as a copolymer containing maleic acid as its monomer component, quaternary ammonium salts, azine-based dyes such as Nigrosine, and carbon black.

The toner particles formed by the above-mentioned toner components may be manufactured by either of the dry method and the wet method, as long as the toner particles satisfy the above-mentioned toner particle conditions such as the average degree of roundness.

In the case of manufacturing the toner particles by using the dry method, the above-mentioned binder resin, colorants and other desired additive agents are mixed, kneaded, pulverized and classified by using conventional methods to obtain particles having a desired particle size; and in the present invention, the particles thus obtained are subjected to an instantaneous heating treatment. The classifying process may be carried out after the instantaneous heating treatment of the present invention has been carried out. In this case, with respect to a pulverizing device used in the pulverizing process, it is preferable to use a pulverizing device that allows the pulverized particles to have a globular shape; this makes it easier to control the succeeding instantaneous heating treatment. Examples of such a device include an Inomizer System (made by Hosokawamicron Corp.) and a Criptron System (made by Kawasaki Heavy Industries Ltd.). With respect to a classifier used in the classifying process, it is preferable to use a classifier that allows the processed particles to have a globular shape; this makes it easier to control the degree of roundness, etc. Examples of such a classifier include a Teeplex-type Classifier (made by Hosokawamicron Corp.).

The instantaneous heating treatment of the present invention may be carried out in combination with various processes for various developers in surface-modifying devices. Examples of these surface-modifying devices include surface-modifying devices using the high-speed gas-flow impact method, such as Hybridization System (made by Nara Machinery Co., Ltd.), a Criptron Cosmos System (made by Kawasaki Heavy Industries Ltd.) and an Inomizer System (made by Hosokawamicron Corp.), surface-modifying devices using the dry mechanochemical method, such as a Mechanofusion System (made by Hosokawamicron Corp.) and a Mechanomill (made by Okadaseiko Co., LTD.), and surface-modifying devices in which the wet coating method is applied, such as a Dispacoat (made by Nisshin Engineering Co., Ltd.) and a Coatmizer (made by Freund Industrial Co., Ltd.). And these devices may be used appropriately in a combined manner.

In the present invention, the application of the instantaneous heating treatment controls the toner particles obtained through the kneading-pulverizing method so as to have a uniform globular shape, reduces thin pores appearing on the surface of the toner particle, and increases the smoothing property.

It is preferable to add various organic/inorganic fine particles to the toner particles to be mixed therein before and/or after the instantaneous heating treatment (fluidizing treatment).

Examples of the inorganic fine particles include various carbides, such as silicon carbide, boron carbide, titanium carbide, zirconium carbide, hafnium carbide, vanadium carbide, tantalum carbide, niobium carbide, tungsten carbide, chromium carbide, molybdenum carbide, calcium carbide and diamond carbon lactam, various nitrides such as boron nitride, titanium nitride and zirconium nitride, bromide such as zirconium bromide, various oxides, such as titanium oxide, calcium oxide, magnesium oxide, zinc oxide, copper oxide, aluminum oxide, silica and colloidal silica, various titanic acid compounds, such as calcium titanate, magnesium titanate and strontium titanate, sulfide such as molybdenum disulfide, fluorides such as magnesium fluoride and carbon fluoride, and various nonmagnetic inorganic fine particles such as talc and bentonite; and these materials may be used alone or in combination. In particular, in the case of the application of inorganic fine particles such as silica, titanium oxide, alumina and zinc oxide, it is preferable to preliminarily carry out a surface treatment by a known method using a conventionally used hydrophobic-property applying agent, such as a silane coupling agent, a titanate coupling agent, silicone oil and silicone vanish, or using a treatment agent, such as a fluorine-based silane coupling agent or fluorine-based silicone oil, a coupling agent having an amino group and a quaternary aluminum salt group, and a modified silicone oil.

With respect to the organic fine particles, various organic fine particles, such as styrene particles, (metha)acrylic particles, benzoguanamine, melamine, Teflon, silicon, polyethylene and polypropylene, which are formed into particles by a wet polymerization method such as an emulsion polymerization method, a soap-free emulsion polymerization method and a non-aqueous dispersion polymerization method, and a vapor phase method, etc, may be used. These organic fine particles also serve as a cleaning-assist agent.

Inorganic fine particles, such as titanate metal salts, having a comparatively large particle size, and various organic fine particles may be, or may not be subjected to a hydrophobic-property applying treatment. The amount of addition of these fluidizing agents is preferably set from 0.1 to 6 parts by weight, and more preferably from 0.5 to 3 parts by weight, with respect to 100 parts by weight of the toner particles. The amount of addition in the externally adding process after the thermal treatment is preferably set from 0.1 to 5 parts by weight, and more preferably from 0.5 to 3 parts by weight, with respect to 100 parts by weight of the toner particles; however, it is preferable to properly adjust the amount of addition before and after the heat treatment.

In the instantaneous heat treatment used in the present invention, toner particles are dispersed and atomized into hot air by compressed air so that the toner particles are surface-modified by heat. At this time, by appropriately selecting heat treatment conditions that will be described below (for example, developer-supplying unit, the number of dispersion nozzles, discharging angle, hot air quantity, dispersion air quantity, suction air quantity, dispersion density, treatment temperature, residence time, cooling air temperature and cooling water temperature), the average degree of roundness (spheroidicity) of toner particles, the standard deviation thereof (uniformity of spheroidicity) and smoothness (surface property) can be set within a predetermined range.

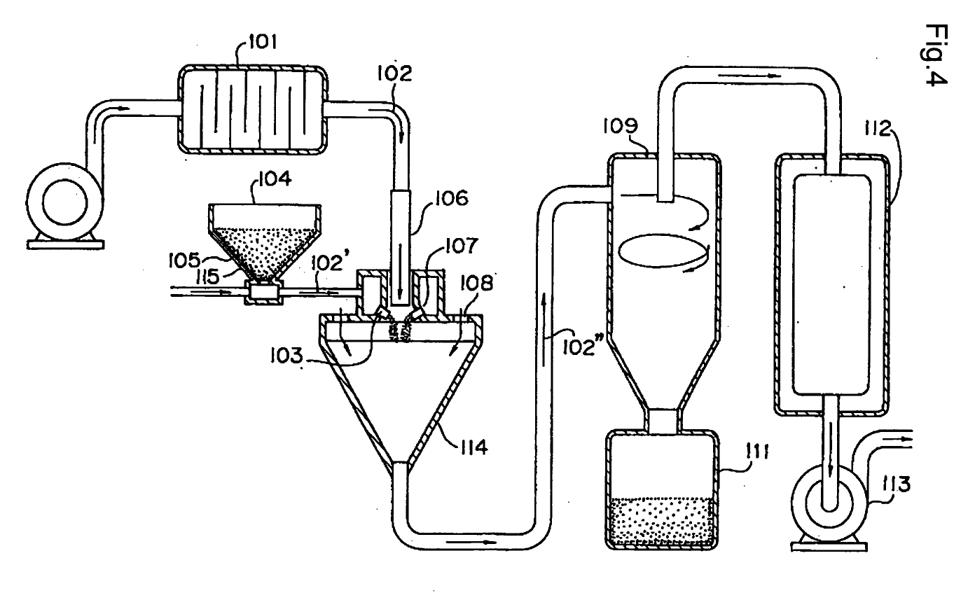

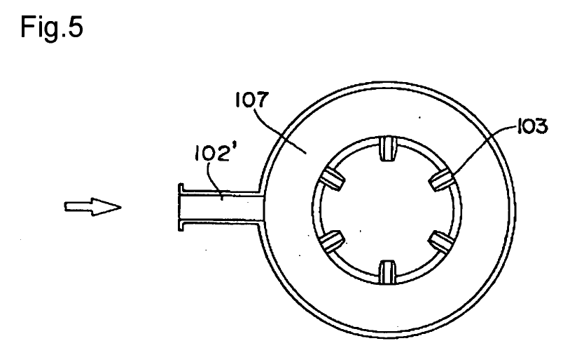

Referring to schematic views of FIGS. 4 and 5, the following description will discuss the construction of a device that carries out the instantaneous heating treatment.

As illustrated in FIG. 4, high-temperature, high-pressure air (hot air), formed in a hot-air generating device 101, is discharged by a hot-air discharging nozzle 106 through a directing tube 102. Toner particles 105 are carried by a predetermined amount of pressurized air from a fixed amount supplying device 104 through a directing tube 102′, and fed to a sample-discharging chamber 107 installed around the hot-air discharging nozzle 106.

As illustrated in FIG. 5, the sample-discharging chamber 107 has a hollow doughnut shape, and a plurality of sample-discharging nozzles 103 are placed on its inside wall with the same intervals. The toner particles, sent to the sample-discharging chamber 107, are allowed to spread inside the discharging chamber 107 in an uniformly dispersed state, and discharged through the sample-discharging nozzles 103 into the hot air flow by the pressure of air successively sent thereto.

It is preferable to provide a predetermined tilt to the sample-discharging nozzles 103 so as not to allow the discharging flow from each sample-discharging nozzle 103 to cross the hot air flow. More specifically, the discharging process is preferably carried out so that the toner discharging flow runs along the hot air flow to a certain extent; and the angle formed by the toner discharging flow and the direction of the central flow of the hot air flow is preferably set in the range of 20 to 40°, more preferably 25 to 35°. The angle wider than 40° causes the toner discharging flow to cross the hot air flow, resulting in collision with toner particles discharged from other nozzles and the subsequent aggregation of the toner particles. In contrast, the angle narrower than 20° leaves some toner particles without being taken in the hot air flow, resulting in irregularity in the toner particle shape.

A plurality of the sample-discharging nozzles 103 are required, and the number thereof is set to at least not less than 3, preferably not less than 4. The application of a plurality of the sample-discharging nozzles makes it possible to uniformly disperse the toner particles into the hot air flow, and to ensure a heating treatment for each of the toner particles. With respect to the discharged state from the sample-discharging nozzle, it is preferably arranged so that the toner particles are widely scattered at the time of discharging, and dispersed over the entire hot air flow without collision with other toner particles.

The toner particles, thus discharged, are allowed to contact the high-temperature hot air instantaneously, and subjected to a heating treatment uniformly. Here, “instantaneously” refers to a time period during which a required toner-particle improvement (heating treatment) has been achieved without causing aggregation between the toner particles; and although it depends on the processing temperature and the density of toner particles in the hot air flow, this is normally set at not more than 2 seconds, and preferably not more than 1 second. This instantaneous time period is represented as a residence time of toner particles from the time when the toner particles are discharged from the sample-discharging nozzles to the time when they are guided into the directing tube 102″. The residence time exceeding 2 seconds tends to cause joined particles.

The toner particles, which have been instantaneously heated, are cooled off by a cold air flow directed from a cooling-air directing section 108, and collected into a cyclone 109 through the directing tube 102″ without adhering to the device walls and causing aggregation between particles, and then stored in a production tank 111. The carrier air from which the toner particles have been removed is allowed to pass through a bug filter 112 by which fine powder is removed therefrom, and released into the air through a blower 113. The cyclone 109 is preferably provided with a cooling jacket through which cooling water runs, so as to prevent aggregation of toner particles.

In addition, important conditions for carrying out the instantaneous heating treatment include an amount of hot air, an amount of dispersing air, a dispersion density, a processing temperature, a cooling air temperature, an amount of suction air and a cooling water temperature.

The amount of hot air refers to an amount of hot air supplied by the hot-air generating device 101. The greater the amount of hot air, the better in an attempt to improve the homogeneity of the heating treatment and the processing performance.

The amount of dispersing air refers to an amount of air that is to be sent to the directing tube 102′ by the pressurized air. Although it also depends on other conditions, the amount of dispersing air is preferably suppressed during the heating treatment; this provides a better dispersed state of toner particles in a stable manner.

The dispersion density refers to a dispersion density of toner particles in a heating treatment area (more specifically, a nozzle discharging area). A preferable dispersion density varies depending on the specific gravity of toner particles; and the value obtained by dividing the dispersion density by the specific gravity of each toner particle is preferably set in the range of 50 to 300 g/m³, and more preferably 50 to 200 g/m³.

The processing temperature refers to a temperature within the heating treatment area. In the heating treatment area, a temperature gradient spreading outwards from the center actually exists, and it is preferable to carry out the heating treatment with this temperature distribution being reduced. From the device viewpoint, it is preferable to supply an air flow in a stable layer-flow state by using a stabilizer or the like. In the case of a non-magnetic toner using a binder resin having a sharp molecular-weight distribution, for example, a binder resin having a ratio of weight-average molecular weight/number-average molecular weight of 2 to 20, it is preferable to carry out the heating treatment in a peak-temperature range of not less than the glass transition point of the binder resin +100° C. to the glass transition point thereof +300° C. It is more preferable to carry out the heating treatment in a peak-temperature range of not less than the glass transition point of the binder resin +120° C. to the glass transition point thereof +250° C. The peak temperature range refers to a maximum temperature in the area in which the toner is allowed to contact the hot air.

In the case of a non-magnetic toner using a binder resin having a binder resin having a comparatively wide molecular-weight distribution, for example, a binder resin having a ratio of weight-average molecular weight/number-average molecular weight of 30 to 100, the processes are preferably carried out in a peak-temperature range of not less than the glass transition point of the binder resin +100° C. to the glass transition point thereof +300° C. More preferably, the processes are carried out in a peak-temperature range of not less than the glass transition point of the binder resin +150° C. to the glass transition point thereof +280° C. This is because in order to improve the shape of the toner particles and the surface uniformity, the processing temperature needs to be set to a higher level so as to modify even the binder resin in a high molecular weight range. However, when the processing temperature is set to a high level, joined particles tend to be generated in a reversed manner so that adjustments such as setting of a higher fluidizing process prior to the heating treatment, and setting of a lower dispersion density at the time of the treatment, are required.

When wax is added to the toner particles, joined particles tend to be generated. For this reason, adjustments are required in which a fluidizing process (especially, fluidizing agent having a large particle size component) prior to the heating treatment is set to a higher level, or the dispersion density is set to a lower level at the time of the treatment, etc. This is essential to obtain uniform toner particles having a uniform shape with suppressed deviations in shape. These operations are particularly important when a binder resin having a relatively wide molecular weight distribution is used or when the processing temperature is set to a high level in an attempt to improve the degree of roundness.

The cooling air temperature refers to a temperature of cold air directed from the cooling-air directing section 108. The toner particles, after having been subjected to an instantaneous heating treatment, are preferably returned to an atmosphere under the glass transition point by using cold air so as to be cooled to a temperature range which causes no aggregation or joining of the toner particles. Therefore, the temperature of the cooling air is set at not more than 25° C., preferably not more than 15° C., and more preferably not more than 10° C. However, an excessive reduction in temperature might cause dew condensation in some conditions and adverse effects; and these points should be taken into consideration. In the instantaneous heating treatment as described above, together with a cooling effect by cooling water in the device as will be described next, since the time in which the binder resin is in a melted state is kept very short, it is possible to eliminate aggregation between the particles and adhesion of the particles to the device walls of the heat treatment device. Consequently, it becomes possible to provide superior stability even during continuous production, to greatly reduce the frequency of cleaning for the manufacturing devices, and to maintain a high yield in a stable manner.

The amount of suction air refers to air used for carrying the processed toner particles to the cyclone by the blower 113. The greater the amount of suction air, the better in reducing the aggregation of the toner particles.

The temperature of cooling water refers to the temperature of cooling water inside the cooling jacket installed in the cyclones 109 and 114 and in the directing tube 102″. The temperature of cooling water is set at not more than 25° C., preferably not more than 15° C., and more preferably not more than 10° C.

In order to improve the spheroidicity (degree of roundness) and to suppress deviations in the shape, it is preferable to further take the following measures.

(1) The amount of toner particles to be supplied to the hot air flow must be kept constant without generating pulsating movements and the like.

For this purpose, (i) a plurality of devices, such as a table feeder 115 shown in FIG. 4 and a vibration feeder, are used in combination so as to improve the fixed-amount supplying property. When a high-precision fixed-amount supply is achieved by using a table feeder and a vibration feeder, finely-pulverizing and classifying processes can be connected thereto so that toner particles can be supplied to the heating treatment process directly on an on-line basis.

(ii) After having been supplied by compressed air, prior to supplying toner particles into hot air, the toner particles are re-dispersed inside the sample-supplying chamber 107 so as to enhance the uniformity. For example, the following measures are adopted: the re-dispersion is carried out by using secondary air; the dispersed state of the toner particles is uniformed by installing a buffer section; and the re-dispersion is carried out by using a co-axial double tube nozzle, etc.

(2) When the toner particles are sprayed and supplied into a hot air flow, the dispersion density thereof should be optimized and controlled uniformly.

For this purpose, (i) the supply into the hot air flow must be carried out uniformly, in a highly dispersed state, from all circumferential directions. More specifically, in the case of supply from dispersion nozzles, those nozzles having a stabilizer, etc. are adopted so as to improve the dispersion uniformity of the toner particles that are dispersed from each of the nozzles.

(ii) In order to uniform the dispersion density of the toner particles in the hot air flow, the number of nozzles is set to at least not less than three, and preferably not less than 4, as described earlier. The greater the number, the better, and these nozzles are placed symmetrically with respect to all the circumferential directions. The toner particles may be supplied uniformly from slit sections installed in all the 360-degree circumferential areas.

(3) Control must be properly made so that no temperature distribution of the hot air is formed in the processing area of toner particles so as to apply uniform thermal energy to each of the particles, and the hot air must be maintained in a layer-flow state.

For this purpose, (i) the temperature fluctuation of a heating source for supplying hot air should be reduced.

(ii) A straight tube section before the hot-air supplying section is made as long as possible. Alternatively, it is preferable to install a stabilizer in the vicinity of the hot-air supplying opening so as to stabilize the hot air. The device construction, shown in FIG. 4 as an example, is an open system; therefore, since the hot air tends to be dispersed in a direction in which it contacts outer air, the supplying opening of the hot air may be narrowed on demands.

(4) The toner particles should be subjected to a sufficient fluidizing treatment so as to be maintained in a uniform dispersed state during the heating treatment.

For this purpose, (i) in order to maintain sufficient dispersing and fluidizing properties of the toner particles, inorganic fine particles (first inorganic fine particles), which have been subjected to a hydrophobic treatment and have a BET specific surface area of 100 to 350 m²/g, preferably 130 to 300 m²/g, are preferably used. The added amount is preferably set in the range of 0.1 to 6 parts by weight, preferably 0.3 to 3 parts by weight, with respect to 100 parts by weight of the toner particles.

(ii) In a mixing process for improving the dispersing and fluidizing properties, each of the fine particles is preferably located on the surface of the toner particle uniformly in an adhering state without being firmly fixed thereon.

(5) Even when the surface of the toner particle is subjected to heat, fine particles which have not been softened should be located on the surface of the toner particle so that a spacer effect is maintained between the toner particles with respect to the surfaces thereof.

For this purpose, (i) it is preferable to add fine particles which have a relatively larger particle size as compared with the fine particles as described in (4), and are not susceptible to softening at processing temperatures. The existence of these particles on the surface of the toner particle prevents the surface of the toner particle from being completely formed by only the resin component even after being subjected to heat, exerts spacer effects between the toner particles, and also prevents aggregation and joining between the toner particles.

(ii) In order to achieve the above-mentioned effects, inorganic fine particles (second inorganic fine particles) which have the primary particles having a BET specific surface area of 10 to 100 m²/g, preferably 20 to 90 m²/g, more preferably 20 to 80 m²/g, are used. The amount of addition is preferably set in the range of 0.05 to 5 parts by weight, more preferably 0.3 to 3 parts by weight, with respect to 100 parts by weight of the toner particles.

In the case when the above-mentioned first inorganic fine particles and second inorganic fine particles are used in combination, it is preferable to set a difference between the BET specific surface areas of the two kinds of fine particles to not less than 30 m²/g, preferably not less than 50 m²/g.

(6) The collection of the heat-treated product should be controlled so as not to generate heat.

For this purpose, (i) the particles that are subjected to the heating treatment and cooling process are preferably cooled in a chiller in order to reduce heat generated in the piping system (especially, in R portions) and in the cyclone normally used in the collection of the toner particles.

Upon manufacturing toner particles through a wet method, a monomer capable of forming a binder resin (for example, the above-mentioned vinyl-based monomer and the like; hereinafter, referred to as “polymerizable monomer”) is allowed to contain various constituent materials such as a colorant, a wax, a charge-controlling agent and a polymerization initiator, and the various constituent materials are dissolved or dispersed in the polymerizable monomer by using a homogenizer, a sand mill, a sand grinder, an ultrasonic dispersing device and the like. The polymerizable composition in which the various constituent materials have been dissolved and dispersed is dispersed in an aqueous solvent containing a dispersion stabilizer by using a homomixer or a homogenizer as oil droplets having a desired size as a toner. Thereafter, this is transferred to a reaction device having stirring blades, and heated while being stirred so that its polymerizing reaction is allowed to progress. After completion of the reaction, the dispersion stabilizer is removed from the resulting resin particles, filtered, washed and further dried so that uniform spherical toner particles are obtained. The colorant, wax, charge-controlling agent may be added to the polymerizable composition independently, or may be added and dispersed in the aqueous solvent. In the case when the colorant, wax and charge-controlling agent are added and dispersed in the aqueous solvent, these may be added at the time of dispersing the polymerizable composition, or may be added to the resin particle dispersion solution after completion of the polymerizing reaction, so that these may be associated or fused with the particles.

The aqueous solvent refers to a solvent containing not less than 50% by mass of water.

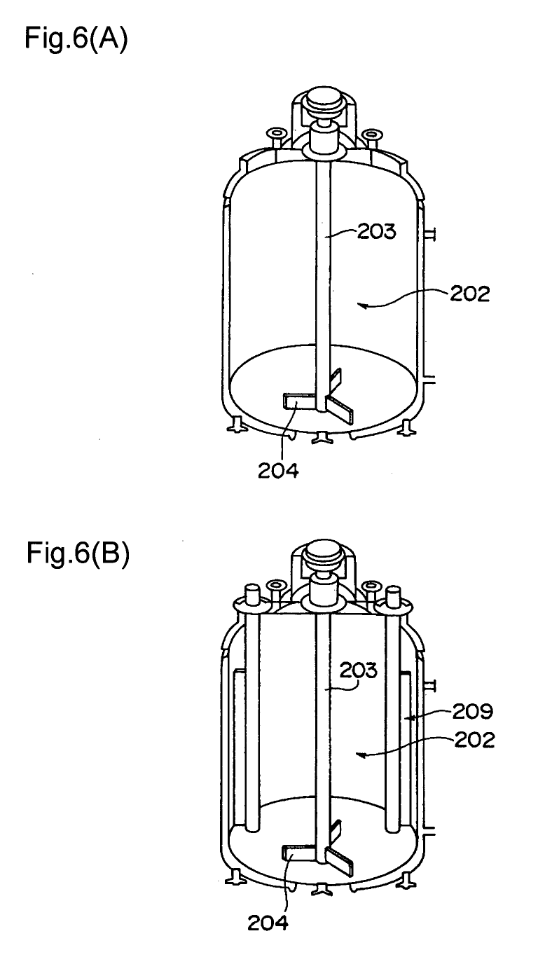

Upon carrying out the polymerizing reaction, the shape of the toner particles is controlled by controlling the flow of the solvent inside the reaction device. In other words, the flow of the medium in the reaction device is formed into layered flows so that it is possible to avoid collision among droplet particles and consequently to provide more uniform and spherical particles. For example, in general, a reaction device as shown in FIG. 6(B) is commonly used. Reference numeral 202 represents a stirring vessel, 203 represents a rotary shaft, 204 represents a stirring blade and 209 represents a turbulent flow forming member. In this device, the turbulent flow forming member 209 is placed on the wall face or the like of the stirring vessel 202 so that a turbulent flow is formed to improve the efficiency of the stirring process. In the present invention, the same device as the above-mentioned device (that is, device shown in FIG. 6(A)) except for the turbulent flow forming member 209 is preferably used to carry out a polymerizing reaction in a state with layered-flows.

The polymerizing reaction may be either of an emulsion polymerizing reaction and a suspension polymerizing reaction, and in particular, the emulsion polymerizing process may be carried out with multiple steps. In other words, the polymerizable composition is emulsion-polymerized in an aqueous solvent under the presence or absence of seeds, and after the resulting resin fine particles dispersion solution and an aqueous solvent prepared in a separated manner have been mixed, to this is further added a polymerizable composition prepared in a separated manner to be stirred therein to carry out an emulsion-polymerizing process. These operations may be carried out repeatedly. In particular, in the case when the emulsion-polymerizing process is carried out in three stages, the wax is preferably added to the polymerizable composition in the second stage.

In another embodiment of the present invention, the polymerizable composition is dispersed in the aqueous solvent as oil droplets having a size in the order of nanometer (for example, 50 to 150 nm) in the above-mentioned wet method, and the resulting resin fine particles are associated or fused with each other in the aqueous solvent to prepare toner particles. In this method, the volume-average particle size, average degree of roundness, standard deviation of degree of roundness and surface properties can be easily controlled. Although not particularly limited, examples of this method include methods disclosed in JP-A No. 5-265252, JP-A No. 6-329947 and JP-A No. 9-15904. In other words, the following methods are proposed:

(1) A method in which resin fine particles, obtained in the same method as the above-mentioned wet method except that the particle size thereof is different, and dispersion particles of the constituent materials such as a colorant, or a plurality of kinds of resin fine particles formed by a resin and a colorant and the like, are associated with one another; and

(2) a method in which, in particular, in the method shown in (1), after the resulting particles have been dispersed in water by using an emulsifier, a flocculant the amount of which is set to not less than a critical aggregation concentration is added thereto to cause salting-out. Simultaneously with the salting-out, the particles are heated and fused at a temperature of not less than the glass transition temperature of the resulting polymer itself to form fused particles, while the particle size is allowed to grow, and at the time when a desired particle size has been achieved, a great amount of water is added thereto to stop the growth of the particle size. The surface of the particle is smoothed while the particles are further heated and stirred to control the shape thereof, and the resulting colored particles in a moistened state are heated and dried in a fluidizing state so that toner particles are formed. Additionally, in this state, an organic solvent having an infinite dissolving property to water may be added simultaneously with the flocculant.

In the above-mentioned method (2), the average degree of roundness, standard deviation of degree of roundness and surface properties can be controlled by appropriately selecting the heating conditions and stirring conditions as well as fluidizing and drying conditions after the stop of the particle-size growth. For example, by increasing the heating temperature within a predetermined range, by increasing the stirring rate within a predetermined range, or by lengthening the stirring time, the average degree of roundness is increased with the standard deviation of degree of roundness being reduced. In particular, when the heating temperature is increased, the surface becomes smoother with an increased value of D/d50.

From the viewpoint of easiness in production, the colorant is preferably added thereto at a stage in which the resin fine particles are aggregated and fused by adding a flocculent.

The following description will discuss preferable materials to be used upon manufacturing toner particles through a wet method.

(Polymerizable Monomer)

With respect to the polymerizable monomer, a hydrophobic monomer is used as an essential constituent component, with a crosslinking monomer being used on demand. At least one kind of monomer having an acidic polar group in its structure or monomer having a basic polar group therein as described below, is preferably used.

Hydrophobic Monomer:

With respect to the hydrophobic monomer forming the monomer component, not particularly limited, conventionally known monomers may be used. In order to satisfy required characteristics, one kind or two kinds or more of the monomers may be used in combination.

More specifically, monovinyl aromatic monomers, (metha)acrylic acid ester monomers, vinyl ester monomers, vinyl ether monomers, monoolefin monomers, diolefin monomers, halogenated olefin monomers and the like may be used.

With respect to the vinyl aromatic monomers, examples thereof include: styrene-based monomers and derivatives thereof, such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene and 3,4-dichlorostyrene.

With respect to the (metha)acrylic acid ester monomers, examples thereof include: acrylic acid, methacrylic acid, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethylβ-hydroxy acrylate, propyly-amino acrylate, stearyl methacrylate, dimethylaminoethyl methacrylate and diethylaminoethyl methacrylate.

With respect to the vinyl ester monomer, examples thereof include vinyl acetate, vinyl propionate and vinyl benzoate, and with respect to the vinyl ether monomer, examples thereof include vinyl methyl ether, vinyl ethyl ether, vinyl isobutyl ether and vinyl phenyl ether.

With respect to the monoolefin monomer, examples thereof include ethylene, propylene, isobutylene, 1-butene, 1-pentene and 4-methyl-1-pentene, and with respect to the diolefin monomer, examples thereof include butadiene, isoprene and chloroprene.

Crosslinking Monomer:

In order to improve the properties of the resin particles, a crosslinking monomer may be added thereto. With respect to the crosslinking monomer, examples thereof include those monomers having two or more unsaturated bonds, such as divinyl benzene, divinyl naphthalene, divinyl ether, diethylene glycol methacrylate, ethylene glycol dimethacrylate, polyethylene glycol dimethacrylate and diallyl phthalate.

(Polymerization Initiator)

With respect to the radical polymerization initiator, any of those initiators may be used as long as it is water-soluble. Examples thereof include persulfates (such as potassium persulfate and ammonium persulfate), azo-based compounds (such as 4,4′-azobis4-cyano valerate and its salt, and 2,2′-azobis(2-amidinopropane) salt) and peroxide compounds. The above-mentioned radical polymerization initiator may be combined with a reducing agent, if necessary, and prepared as a redox initiator.

(Chain Transfer Agent)

In order to adjust the molecular weight, a known chain transfer agent may be added thereto. With respect to the chain transfer agent, although not particularly limited thereto, examples thereof include compounds having a mercapto group such as octyl mercaptan, dodecyl mercaptan and tert-dodecyl mercaptan. In particular, the compound having a mercapto group makes it possible to suppress generation of offensive odor at the time of heat-fixing, and also to provide a toner that has a sharp molecular weight distribution, and is superior in shelf life, fixing strength and anti-offset property; thus, it is preferably used. Preferable examples thereof include: ethyl thioglycolate, propyl thioglycolate, butyl thioglycolate, t-butyl thioglycolate, 2-ethylhexyl thioglycolate, octyl thioglycolate, decyl thioglycolate, dodecyl thioglycolate, compounds of ethylene glycol having a mercapto group, compounds of neopentyl glycol having a mercapto group and compounds of pentaerythritol having a mercapto group.

(Surfactant)

In order to carry out, in particular, a mini-emulsion polymerizing process, it is preferable to disperse oil droplets in an aqueous solvent by using a surfactant. With respect to the surfactant to be used in this process, for example, although not particularly limited thereto, the following ionic surfactants are proposed as preferable compounds.

With respect to the ionic surfactant, examples thereof include sulfonates (such as sodium dodecylbenzene sulfonate, sodium arylalkylpolyether sulfonate, sodium 3,3-disulfonediphenyl urea-4,4-diazo-bis-amino-8-naphthol-6-sulfonate, ortho-carboxybenzene-azo-dimethyl aniline and 2,2,5,5-tetramethyl-triphenyl methane-4,4-diazo-bis-β-naphthol-6-sulfonate), sulfates (such as sodium dodecyl sulfate, sodium tetradecyl sulfate, sodium pentadecyl sulfate and sodium octyl sulfate), and fatty acid salts (such as sodium oleate, sodium laurate, sodium caprinate, sodium caprylate, sodium capronate, potassium stearate and calcium oleate).

(Flocculant)

In the processes in which resin fine particles are salt-extracted, aggregated and fused from a dispersion solution of the resin fine particles that have been prepared in an aqueous medium, metal salts are preferably used as the flocculant, and divalent or trivalent metal salts are more preferably used as the flocculent.

Specific examples of these metal salts are described below: With respect to the monovalent metal salts, examples thereof include sodium chloride, potassium chloride and lithium chloride; with respect to the divalent metal salts, examples thereof include calcium chloride, zinc chloride, copper sulfate, magnesium sulfate and manganese sulfate; and with respect to the trivalent metal salts, examples thereof include aluminum chloride and iron chloride.

Each of these flocculants is preferably added at a concentration exceeding its critical aggregation concentration. The critical aggregation concentration refers to an index that relates to the stability of a dispersed matter in an aqueous dispersion solution, and indicates a concentration of added flocculant at the time when the added flocculant causes aggregation. The critical aggregation concentration varies greatly depending on the latex itself and the dispersant. For example, this term is described in Polymer Chemistry 17, 601 (1960), written by Seizo Okamura, etc., and its specific value is available from the descriptions of these. Alternatively, another method is proposed in which a desired salt is added to a dispersion solution of target particles with varied concentrations, and the ξ electric potential of the dispersion solution is measured so that the salt concentration at which the 4 electric potential starts to change is defined as the critical aggregation concentration.

(Colorant)

The toner of the present invention is also preferably obtained by subjecting the above-mentioned composite resin particles and colorant particles to salting-out and/or fusing treatments. With respect to the colorant (colorant particles to be subjected to salting-out and/or fusing treatments with the composite resin particles) of the present invention, various kinds of inorganic pigments, organic pigments and dyes are listed.

With respect to the inorganic pigments, conventionally known pigments may be used. Specific examples of the inorganic pigments are shown below:

With respect to the black pigments, examples thereof include: carbon blacks such as Furnace Black, Channel Black, Acetylene Black, Thermal Black and Lamp Black, and magnetic powder such as magnetite and ferrite.

With respect to the inorganic pigments, conventionally known pigments may be used. Specific examples of the inorganic pigments are shown below:

With respect to magenta or red pigments, examples thereof include: C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178 and C.I. Pigment Red 222.

With respect to yellow pigments, examples thereof include: C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, C.I. Pigment Yellow 138, C.I. Pigment Yellow 180, C.I. Pigment Yellow 185, C.I. Pigment Yellow 155 and C.I. Pigment Yellow 156.

With respect to green or cyan pigments, examples thereof include: C.I. Pigment Blue 15, C.I. Pigment Blue 15:2, C.I. Pigment Blue 15:3, C.I. Pigment Blue 16, C.I. Pigment Blue 60 and C.I. Pigment Green 7.

With respect to dyes, examples thereof include: C.I. Solvent Reds 1, 49, 52, 58, 63, 111 and 122; C.I. Solvent Yellows 19, 44, 77, 79, 81, 82, 93, 98, 103, 104, 112 and 162; and C.I. Solvent Blues 25, 36, 60, 70, 93 and 95. A mixture of these may be used.

(Crystalline Substance)

With respect to a crystalline substance having a mold-releasing function, to the toner of the present invention, the following waxes are added as polyolefin-based waxes such as low-molecular weight polypropylene and low-molecular weight polyethylene: San Wax E300 (softening point 103.5° C., acid value 22), San Wax E250P (softening point 103.5° C., acid value 19.5), Viscol 200TS (softening point 140° C., acid value 3.5), Viscol 100TS (softening point 140° C., acid value 3.5) and the like, made by Sanyo Chemical Industries Ltd., and the following materials are added as monofunctional and multifunctional ester waxes: myristyl alcohol, ethylene glycol, trimethylol ethane, pentaerythritol, glucose and dipentaerythritol.

With respect to the toner particles obtained through a wet method or a dry method as described above, toner is preferably obtained by blending and externally adding not only the above-mentioned fatty acid metal salt, but also post-process agents such as the above-mentioned inorganic fine particles or organic fine particles thereto. It is preferable to use inorganic fine particles having a BET specific surface area of 1 to 350 m²/g as the post-process agents.

In order to improve the fluidity of the toner, it is preferable to use those having a BET specific surface area of 100 to 350 m²/g, preferably 130 to 300 m²/g, as the inorganic fine particles for post-processes. These inorganic fine particles are preferably subjected to a hydrophobic property-applying treatment by a known hydrophobic-property applying agent. The amount of addition of the inorganic fine particles is set to 0.1 to 3% by weight, preferably 0.3 to 1% by weight, with respect to the toner particles. In the case of using two kinds or more of the fine particles, the total amount of addition thereof is appropriately set within the above-mentioned range.

In order to improve the toner's environmental stability and endurance stability, those having a BET specific surface area of 1 to 100 m²/g, preferably 5 to 90 m²/g, more preferably 5 to 80 m²/g, are used as the inorganic fine particles for post-processes. The added amount of the inorganic fine particles is set to 0.05 to 5% by weight, preferably 0.3 to 4% by weight, with respect to the toner particles. In the case of using two or more kinds of these, the total added amount thereof is set in the above-mentioned range.

In the case when the inorganic fine particles for improving fluidity and the inorganic fine particles for improving stability are used in combination, the difference between the BET specific surface areas of the two is set to not less than 30 m²/g, preferably not less than 50 m²/g.

### EXAMPLES

In the following examples, “parts” indicates “parts by weight”.

### Production Examples of Polyester Resins A

To a four-neck flask provided with a thermometer, a stainless stirring stick, a dropping-type condenser and a nitrogen gas directing tube were loaded polyoxypropylene(2,2)-2,2-bis(4-hydroxyphenyl)propane, polyoxyethylene(2,0)-2,2-bis(4-hydroxyphenyl)propane and terephthalic acid, which were adjusted to a mole ratio of 4:6:9, together with a polymerization initiator (dibutyltinoxide). This was allowed to react in a mantle heater by applying heat while being stirred under a nitrogen gas flow. The progress of the reaction was traced by measuring its acid value. At the time of reaching a predetermined acid value, the reaction was completed, and this was cooled to room temperature; thus, a polyester resin was obtained. The polyester resin was coarsely pulverized into not more than 1 mm, and this was used in manufacturing toners, which will be described later. Polyester resin A thus obtained has a softening point (Tm) of 110.3° C., a glass transition point (Tg) of 68.5° C., an acid value of 3.3 KOHmg/g, a hydroxyl value of 28.1 KHOmg/g, a number-average molecular weight (Mn) of 3300, and a ratio of weight-average molecular weight (Mw)/number-average molecular weight (Mn) of 4.2.

### Production Examples of Polyester Resins B and C

Resins B and C were obtained by carrying out the same processes as the production example of polyester resin A, except that the alcohol component and the acid component were changed to have mole ratios as shown in Table 1.

TABLE 1

| Pol- | | | | | | | | | | | | Hydroxyl |
|---|---|---|---|---|---|---|---|---|---|---|---|---|
| yester | Alcohol component | | | Acid component | | | | | Tg | Tm | Acid value | value |
| resin | PO | EO | GL | FA | TPA | TMA | Mn | Mw/Mn | (° C.) | (° C.) | (KOHmg/g) | (KOHmg/g) |
| A | 4.0 | 6.0 | — | — | 9.0 | — | 3300 | 4.2 | 68.5 | 110.3 | 3.3 | 28.1 |
| B | 5.0 | 5.0 | — | 5.0 | 4.0 | — | 3800 | 3.0 | 68.3 | 102.8 | 3.8 | 28.7 |
| C | 3.0 | 7.0 | — | — | 7.0 | 2.0 | 2800 | 2.3 | 59.5 | 101.8 | 1.3 | 60.4 |

### Production Example of Polyester Resin D

To a four-neck glass flask provided with a thermometer, a stirrer, a dropping-type condenser and a nitrogen gas directing tube were loaded polyoxypropylene(2,2)-2,2-bis(4-hydroxyphenyl)propane, polyoxyethylene(2,2)-2,2-bis(4-hydroxyphenyl)propane, isododecenyl succinic anhydride, terephthalic acid and fumaric acid so as to be adjusted at a weight ratio of 82:77:16:32:30, together with dibutyl tin oxide as a polymerization initiator. This was allowed to react in a mantle heater while being stirred at 220° C. under a nitrogen gas atmosphere. A polyester resin D thus obtained had a softening point of 110° C., a glass transition point of 60° C. and an acid value of 17.5 KOH mg/g.

### Production Example of Polyester Resin E

Styrene and 2-ethylenehexylacrylate were adjusted to a weight ratio of 17:3.2, and this was loaded into a dropping funnel together with dicumylperoxide as a polymerization initiator. To a four-neck glass flask provided with a thermometer, a stirrer, a dropping-type condenser and a nitrogen gas directing tube were loaded polyoxypropylene(2,2)-2,2-bis(4-hydroxyphenyl)propane, polyoxyethylene(2,2)-2,2-bis(4-hydroxyphenyl)propane, isododecenyl succinic anhydride, terephthalic acid, 1,2,4-benzenetricarboxylic anhydride and acrylic acid so as to be adjusted at a weight ratio of 42:11:11:11:8:1, together with dibutyl tin oxide as a polymerization initiator. This was stirred at 135° C. in a mantle heater under a nitrogen gas atmosphere, with styrene, etc. being dropped therein from the dropping funnel, and then heated to 230° C. at which reaction was carried out. A polyester resin E thus obtained had a softening point of 150° C., a glass transition point of 62° C. and an acid value of 24.5 KOH mg/g.

[Production of toner]
<Magenta master batch>

| | |
|---|---|
| Polyester resin A | 70 parts by weight |
| (Tg: 60.5° C., Tm: 110.3° C.) | |
| Magenta pigment | 30 parts by weight |
| (C.I. Pigment Red 184) | |

A mixture having the above composition was fed into a pressure kneader, and mixed and kneaded. After having been cooled, the resultant kneaded matter was pulverized by a feather mill, thereby obtaining a pigment master batch.

(Toner particles A1)

| | |
|---|---|
| Polyester resin A | 93 parts by weight |
| Above-mentioned master batch | 10 parts by weight |
| Zinc salicylate metal complex | 2 parts by weight |
| (E-84: Orient Chemical Industries, LTD.) | |

Acid-type low molecular polypropylene 2 parts by weight

(Viscol TS-200; Sanyo Chemical Industries Ltd.)

The above-mentioned materials were sufficiently mixed by a Henschel Mixer, and then melted and kneaded by using a twin screw extruder kneader (PCM-30; made by Ikegai Ltd.) whose discharging nozzle had been expanded in its diameter, and the resultant kneaded matter was quickly cooled, and coarsely pulverized by a feather mill. The pulverized matter was pulverized and coarsely classified by a Jet mill (IDS: made by Nippon Pneumatic Mfg. Co., Ltd.), and then finely classified by a DS classifier (made by Nippon Pneumatic Mfg. Co., Ltd.); thus, toner particles having a weight-average particle size of 6.1 μm were obtained.

To 100 parts by weight of the toner particles were added 0.5 parts by weight of hydrophobic silica having a BET specific surface area of 225 m²/g (TS-500: made by Showa Cabot K.K.) and 1.0 part by weight of hydrophobic silica (AEROSIL 90G: made by Nippon Aerosil Co., Ltd.) subjected to a modifying treatment by hexamethylenedisilazane: BET specific surface area 65 m²/g, pH 6.0 (degree of hydrophobic property: not less than 65%), and this was mixed by a Henschel mixer (peripheral speed 40 m/sec, for 60 seconds), and then subjected to a surface-modifying treatment by heat under the following conditions by using an instantaneous heating device having a structure as shown in FIG. 4; thus, toner particles A1 (weight-average particle size 6.1 μm) were obtained.

(Conditions of Surface-Modifying Treatment)

Developer supplying section; Table feeder+vibration feeder

Dispersing nozzle; Four (Symmetric layout with 90 degrees respectively to all circumference)

Discharging angle; 30 degrees

Amount of hot air; 880 L/min

Amount of dispersing air; 55 L/min

Amount of suction air; −1200 L/min

Dispersion density; 100 g/m³

Processing temperature; 250° C.

Residence time; 0.5 second

Temperature of cooling air; 15° C.

Temperature of cooling water; 10° C.

(Toner Particles A2-A5)

The same manufacturing method as toner particles A1 was carried out except that fine particle classifying conditions were changed in the manufacturing method of toner particles A1 so as to change the weight-average particle size of the toner particles, thereby obtaining toner particles A2 to A5.

Toner particles A2: weight-average particle size 4.1 μm

Toner particles A3: weight-average particle size 5.1 μm

Toner particles A4: weight-average particle size 3.2 μm

Toner particles A5: weight-average particle size 7.0 μm

(Toner Particles A6-A8)

The same method and compositions as those of production example of toner particles A1 were used except that the weight-average particle size was changed to 6.1 μm and that processing temperatures were changed to 200° C., 300° C. and 220° C., thereby obtaining toner particles A6 to A8.

(Toner Particles A9)

The same method and compositions as those of toner particles A1 were used except that the amount of polyester resin A was changed to 100 parts by weight and that the pigment master batch was changed to 4 parts by weight of carbon black (Mogul L; made by Cabot Corporation), thereby obtaining toner particles A9.

(Toner Particles A10) (Oil-Less Fixing Black Toner)

Polyester resin D (40 parts by weight), 60 parts by weight of polyester resin E, 2 parts by weight of polyethylene wax (800P; made by Mitsui Chemicals Inc.; melt viscosity 5400 cps at 160° C.; softening point 140° C.), 2 parts by weight of polypropylene wax (TS-200; made by Sanyo Chemical Industries Ltd.; melt viscosity 120 cps at 160° C.; softening point 145° C.; acid value 3.5 KOHg/g), 8 parts by weight of acidic carbon black (Mogul-L; made by Cabot Corporation; pH 2.5; average primary particle size 24 nm) and 2 parts by weight of a negative charge-control agent represented by the following formula were sufficiently mixed by a Henschel mixer, and melt-kneaded by a twin screw extruder kneader.

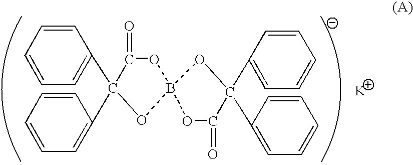

Then, this was cooled off, coarsely pulverized by a hammer mill, and finely pulverized by a jet mill, and then classified; thus toner particles having a weight-average particle size of 6.3 μm were obtained.

The same method and compositions as example of production for toner particles A1 were used except that the amount of fluidizing process prior to the heat treatment was changed to 0.6 parts by weight of hydrophobic silica (TS-500: made by Showa Cabot K.K.) and 1.2 parts by weight of hydrophobic silica (AEROSIL 90G; made by Nippon Aerosil Co., Ltd.) subjected to a modifying treatment by hexamethylenedisilazane; BET specific surface area 65 m²/g, pH 6.0, degree of hydrophobic property; not less than 65%, and that with respect to the surface-modifying conditions, the processing temperature was changed to 270° C., thereby obtaining toner particles A10 (weight-average particle size 6.3 μm).

(Toner Particles A11)

The same compositions as production method for toner particles A1 were used except that the ratio of blending of polyester resin B and resin C was changed to 20:80, thereby obtaining toner particles A11 (weight-average particle size 6.3 μm).

(Toner Particles A12)

The same compositions as production method for toner particles A11 were used except that the amounts of polyester resin B and polyester resin C were respectively changed to 20 parts by weight and 80 parts by weight and that the pigment master batch was changed to 4 parts by weight of carbon black (Mogul-L; made by Cabot Corporation), thereby obtaining toner particles A12 (weight-average particle size 6.3 μm).

(Toner Particles A13)

By changing the fine particle classifying conditions in production method of toner particles A1, toner particles having a weight-average particle diameter of 7.3 μm were obtained. To 100 parts by weight of the toner particles was added 1.0 part by weight of hydrophobic silica (RX-200: made by Nippon Aerosil Co., Ltd.; BET specific surface area 140 m²/g, pH 7.0), and this was subjected to a surface-modifying treatment by heat under the following conditions; thus, toner particles A13 having a weight-average particle size of 7.3 μm were obtained.

(Conditions of Surface-Modifying Treatment)

Developer supplying section; Table feeder

Dispersing nozzle; Two (Symmetric layout with 90 degrees respectively to all circumference)

Discharging angle; 45 degrees

Amount of hot air; 620 L/min

Amount of dispersing air; 68 L/min

Amount of suction air; −900 L/min

Dispersion density; 150 g/m³

Processing temperature; 300° C.

Residence time; 0.5 second

Temperature of cooling air; 30° C.

Temperature of cooling water; 20° C.

(Toner Particles A14)

The same method and compositions as production example of toner particles A7 were used except that the processing temperature was changed to 150° C. (weight average particle size 6.1 μm), thereby obtaining toner particles A14.

(Toner Particles A15)

The particles of toner particles A5 prior to the heat treatment were used as toner particles A15.

(Toner Particles B1) (Examples of Emulsion-Polymerization Method)

<First Stage Polymerization>

To a 5000 ml reaction container equipped with a stirring device, a temperature sensor, a cooling tube and a nitrogen gas directing device was charged a surfactant solution (aqueous solvent) prepared by dissolving 7.08 g of an anionic surfactant C₁₀H₂₁(OCH₂CH₂)₂OSO₃Na in 3010 g of ion exchange water, and this was heated to a temperature of 80° C. in the reaction container, while being stirred at a stirring speed of 230 rpm under a nitrogen gas flow.

To this surfactant solution was added an initiator solution prepared by dissolving 9.2 g of a polymerization initiator (potassium persulfate: KPS) in 200 g of ion exchange water, and after the temperature thereof has been set to 75° C., a monomer mixed solution containing 70.1 g of styrene, 19.9 g of n-butyl acrylate, 10.9 g of methacrylic acid and 10.0 g of t-dodecyl mercaptan was dripped therein in one hour, and this system was heated and stirred at 80° C. for 2 hours to carry out a polymerization process (first stage polymerization) to prepare a latex (dispersion solution of resin particles made from a high-molecular-weight resin).

<Second Stage Polymerization>

In a flask equipped with a stirring device, to a monomer mixed solution containing 105.6 g of styrene, 30.0 g of n-butyl acrylate, 6.2 g of methacrylic acid and 5.6 g of t-dodecyl mercaptan was added 98.0 g of WEP-5 (made by NOF Corporation), and heated to 80° C. to be dissolved; thus, a monomer solution was prepared.

A surfactant solution, prepared by dissolving 1.6 g of the anionic surfactant (indicated by the above-mentioned formula) in 2700 ml of ion exchange water, was heated to 82° C., and, after 28 g of the above-mentioned latex as expressed in terms of solid component equivalent that served as the dispersion medium of nucleus particles has been added to this surfactant solution, the above-mentioned WEP-5 monomer solution was mixed and dispersed therein in 0.5 hour by using a mechanical dispersing machine “CLEARMIX” having a circulation path (made by M Technique) to prepare a dispersion solution (emulsion solution) containing emulsified particles (oil droplets).

To this dispersion solution (emulsion solution) were added an initiator solution prepared by dissolving 5.1 g of a polymerization initiator (KPS) in 240 ml of ion exchange water, and 750 ml of ion exchange water, and this system was heated while being stirred at 82° C. for 12 hours to carry out a polymerization process (second stage polymerization) to prepare a latex (dispersion solution of resin particles, each having a structure in which the surface of a resin particle made from a high-molecular-weight resin coated with a resin made from an intermediate-molecular-weight resin). This forms “latex 1”.

<Third Stage Polymerization>

To latex 1 obtained as described above was added an initiator solution prepared by dissolving 7.4 g of a polymerization initiator (KPS) in 200 ml of ion exchange water, and to this was dripped a monomer mixed solution containing 300 g of styrene, 95 g of n-butyl acrylate, 15.3 g of methacrylic acid and 10.0 g of n-octyl-3-mercaptopropionate in one hour under a temperature condition of 80° C. After completion of the dripping process, this was heated and stirred for 2 hours so as to carry out a polymerization process (third polymerization), and cooled to 28° C. so that a latex (a dispersion solution of resin fine particles, each of which has a center portion made from a high-molecular-weight resin, an intermediate layer made from an intermediate-molecular-weight resin and an outer layer made from a low-molecular-weight resin with the intermediate layer containing WEP-5) was obtained. This latex forms “latex 2”.

The resin fine particles forming this latex 2 had peak molecular weights at 20,000 and 80,000, and the weight-average particle size of the resin fine particles was 130 nm.

To a reaction container (four-neck flask) equipped with a temperature sensor, a cooling tube, a nitrogen gas directing device and a stirring device were charged and stirred 420.7 g of latex 2 (as expressed in terms of solid component equivalent), 900 g of ion exchange water and 1166 g of a colorant dispersion solution. After the temperature inside the container had been adjusted to 30° C., a 5-N sodium hydroxide aqueous solution was added to this solution to adjust the pH to 8 to 10.0.

An aqueous solution, prepared by dissolving 12.1 g of magnesium chloride 6 hydrate in 1,000 ml of ion exchange water, was dripped therein at 30° C. in 10 minutes, while being stirred. After having been left for 3 minutes, this was heated to 84° C. to form associated particles (association time: 90 minutes). In this state, the particle size of the associated particles was measured by “Coulter Counter TA-II”, and at the time when the number-average particle size was set to 6.1 μm, an aqueous solution, prepared by dissolving 80.4 g of sodium chloride in 1,000 ml of ion exchange water, was added thereto to stop the growth of the particles, and this was heated and stirred at a solution temperature of 98° C. for 2 hours as a maturing treatment so that the fusion of the particles and the phase separation of the crystalline substance were continued (maturing process).

Thereafter, this was cooled to 30° C., and the pH thereof was adjusted to 2.0 by adding hydrochloric acid, and the stirring process was stopped. The associated particles thus formed were filtered, and washed with ion exchange water at 45° C. repeatedly, and then dried by hot air at 40° C. so that toner particles B1 were obtained.

(Toner Particles B2)

The same manufacturing method as toner particles B1 was carried out except that the association time was changed to 45 minutes to prepare toner particles B2.

(Toner Particles B3)

The same manufacturing method as toner particles B1 was carried out except that the association time was changed to 60 minutes to prepare toner particles B3.

(Toner Particles B4)

The same manufacturing method as toner particles B1 was carried out except that the association time was changed to 30 minutes to prepare toner particles B4.

(Toner Particles B5)

The same manufacturing method as toner particles B1 was carried out except that the association time was changed to 120 minutes to prepare toner particles B5.

(Toner Particles B6)

The same manufacturing method as toner particles B1 was carried out except that the maturing process temperature was changed to 94° C., with the maturing process stirring time being changed to 4 hours, to prepare toner particles B6.

(Toner Particles B7)

The same manufacturing method as toner particles B1 was carried out except that the maturing process temperature was changed to 99° C., with the maturing process stirring time being changed to 8 hours, to prepare toner particles B7.

(Toner Particles B8)

The same manufacturing method as toner particles B1 was carried out except that the maturing process temperature was changed to 94° C., with the maturing process stirring time being changed to 5 hours, to prepare toner particles B8.

(Toner Particles B9)

### Example of Suspension Polymerization Method

Styrene (165 g), n-butyl acrylate (35 g), carbon black (10 g), di-t-butyl salicylic acid metal compound (2 g), styrene-methacrylic acid copolymer (8 g) and paraffin wax (20 g) (mp=70° C.) were heated to 60° C., and dissolved and dispersed uniformly by a TK homomixer (made by Tokushu Kika Kogyo Co., Ltd.) at 12,000 rpm. This was used as a polymerization initiator, and to this was added and dissolved 10 g of 2,2′-azobis(2,4-valeronitrile) so that a polymerizable monomer composition was prepared. To 710 g of ion exchange water was added 450 g of an aqueous solution of 0.1 M sodium phosphate, and to this was gradually added 68 g of 1.0 M calcium chloride while being stirred by a TK homomixer at 13000 rpm to prepare a suspension in which tricalcium phosphate was dispersed. The above-mentioned polymerizable monomer composition was added to this suspension, and stirred by a TK homomixer at 1,0000 rpm for 20 minutes to granulate the polymerizable monomer composition. Thereafter, this was allowed to react at 75 to 95° C. for 5 to 15 hours. Tricalcium phosphate was dissolved and removed by hydrochloric acid and a classifying process was carried out in the solution through a centrifugal precipitation method by using a centrifugal separator, and the resulting solution was filtered, washed and dried so that toner particles B 9 were obtained.

(Toner Particles B10)

The same manufacturing method as toner particles B1 was carried out except that the association time was changed to 130 minutes to prepare toner particles B10.

(Toner Particles B11)

The same manufacturing method as toner particles B1 was carried out except that the maturing process temperature was changed to 92° C., with the maturing process stirring time being changed to 1.5 hours, to prepare toner particles B11.

(Toner Particles B12)

The same manufacturing method as toner particles B5 was carried out except that the maturing process temperature was changed to 92° C., with the maturing process stirring time being changed to 1 hour, to prepare toner particles B12.

### Examples and Comparative Examples

To each of the toner particles shown in Tables 2 to 5 was added calcium stearate having each of volume-average particle sizes shown in the Tables at each of amounts shown in the Tables, and to this were further added 1.0% by weight of hydrophobic silica having a BET specific surface area of 225 m²/g (TG-811F, made by made by Showa Cabot K.K.), 1.5% by weight of strontium titanate having a BET specific surface area of 9 m²/g and 1.0% by weight of NX 90 having a BET specific surface area of 65 m²/g (made by Nippon Aerosil Co., Ltd.), and mixed to obtain a non-magnetic mono-component developing toner.

TABLE 2

| | | | | | | SCP | | Press | Press |
|---|---|---|---|---|---|---|---|---|---|
| | Toner | Particle | Degree of | SD | | Particle | Amount of | contact | contact |
| | particle | size | roundness | value | D/d50 | size | addition | angle | force |
| Ex. A1 | A1 | 6.1 | 0.984 | 0.027 | 0.55 | 5 | 0.01 | 15 | 30 |
| Ex. A2 | A2 | 4.1 | 0.988 | 0.026 | 0.54 | 5 | 0.01 | 15 | 30 |
| Ex. A3 | A3 | 5.1 | 0.986 | 0.028 | 0.55 | 5 | 0.01 | 15 | 30 |
| Ex. A4 | A4 | 3.2 | 0.99 | 0.025 | 0.56 | 5 | 0.01 | 15 | 30 |
| Ex. A5 | A5 | 7 | 0.981 | 0.026 | 0.54 | 5 | 0.01 | 15 | 30 |
| Ex. A6 | A6 | 6.1 | 0.96 | 0.034 | 0.55 | 5 | 0.01 | 15 | 30 |
| Ex. A7 | A7 | 6.1 | 0.994 | 0.018 | 0.52 | 5 | 0.01 | 15 | 30 |
| Ex. A8 | A8 | 6.1 | 0.971 | 0.027 | 0.54 | 5 | 0.01 | 15 | 30 |
| Ex. A9 | A9 | 6.1 | 0.985 | 0.027 | 0.54 | 5 | 0.01 | 15 | 30 |
| Ex. A10 | A10 | 6.3 | 0.983 | 0.03 | 0.53 | 5 | 0.01 | 15 | 30 |
| Ex. A11 | A11 | 6.3 | 0.982 | 0.028 | 0.55 | 5 | 0.01 | 15 | 30 |
| Ex. A12 | A12 | 6.3 | 0.982 | 0.028 | 0.55 | 5 | 0.01 | 15 | 30 |
| Ex. A13 | A1 | 6.1 | 0.984 | 0.027 | 0.55 | 5 | 0.1 | 15 | 30 |
| Ex. A14 | A1 | 6.1 | 0.984 | 0.027 | 0.55 | 5 | 0.001 | 15 | 30 |
| Ex. A15 | A1 | 6.1 | 0.984 | 0.027 | 0.55 | 5 | 0.008 | 15 | 30 |
| Ex. A16 | A1 | 6.1 | 0.984 | 0.027 | 0.55 | 2 | 0.01 | 15 | 30 |
| Ex. A17 | A1 | 6.1 | 0.984 | 0.027 | 0.55 | 10 | 0.01 | 15 | 30 |
| Ex. A18 | A1 | 6.1 | 0.984 | 0.027 | 0.55 | 5 | 0.01 | 20 | 50 |
| Ex. A19 | A1 | 6.1 | 0.984 | 0.027 | 0.55 | 5 | 0.01 | 10 | 20 |

TABLE 3

| | | | | | | SCP | | Press | Press |
|---|---|---|---|---|---|---|---|---|---|
| | Toner | Particle | Degree of | SD | | Particle | Amount of | contact | contact |
| | particle | size | roundness | value | D/d50 | size | addition | angle | force |
| Com. Ex. A1 | A13 | 7.3 | 0.988 | 0.046 | 0.54 | 5 | 0.01 | 15 | 30 |
| Com. Ex. A2 | A14 | 6.1 | 0.955 | 0.03 | 0.035 | 5 | 0.01 | 15 | 30 |
| Com. Ex. A3 | A15 | 7 | 0.945 | 0.028 | 0.038 | 5 | 0.01 | 15 | 30 |
| Com. Ex. A4 | A1 | 6.1 | 0.984 | 0.027 | 0.55 | 1 | 0.01 | 15 | 30 |
| Com. Ex. A5 | A1 | 6.1 | 0.984 | 0.027 | 0.55 | 15 | 0.01 | 15 | 30 |
| Com. Ex. A6 | A1 | 6.1 | 0.984 | 0.027 | 0.55 | 5 | 0.15 | 15 | 30 |
| Com. Ex. A7 | A1 | 6.1 | 0.984 | 0.027 | 0.55 | 5 | 0.01 | 21 | 30 |
| Com. Ex. A8 | A1 | 6.1 | 0.984 | 0.027 | 0.55 | 5 | 0.01 | 9 | 30 |
| Com. Ex. A9 | A1 | 6.1 | 0.984 | 0.027 | 0.55 | 5 | 0.01 | 15 | 51 |
| Com. Ex. A10 | A1 | 6.1 | 0.984 | 0.027 | 0.55 | 5 | 0.01 | 15 | 19 |
| Com. Ex. A11 | A1 | 6.1 | 0.984 | 0.027 | 0.55 | — | no addition | 15 | 30 |

TABLE 4

| | | | | | | SCP | | Press | Press |
|---|---|---|---|---|---|---|---|---|---|
| | Toner | Particle | Degree of | SD | | Particle | Amount of | contact | contact |
| | particle | size | roundness | value | D/d50 | size | addition | angle | force |
| Ex. B1 | B1 | 6.1 | 0.985 | 0.027 | 0.55 | 5 | 0.01 | 15 | 30 |
| Ex. B2 | B2 | 4.0 | 0.988 | 0.026 | 0.54 | 5 | 0.01 | 15 | 30 |
| Ex. B3 | B3 | 5.0 | 0.986 | 0.028 | 0.55 | 5 | 0.01 | 15 | 30 |
| Ex. B4 | B4 | 3.2 | 0.99 | 0.025 | 0.56 | 5 | 0.01 | 15 | 30 |
| Ex. B5 | B5 | 7.0 | 0.981 | 0.026 | 0.54 | 5 | 0.01 | 15 | 30 |
| Ex. B6 | B6 | 6.1 | 0.96 | 0.032 | 0.55 | 5 | 0.01 | 15 | 30 |
| Ex. B7 | B7 | 6.1 | 0.993 | 0.019 | 0.52 | 5 | 0.01 | 15 | 30 |
| Ex. B8 | B8 | 6.1 | 0.971 | 0.027 | 0.54 | 5 | 0.01 | 15 | 30 |
| Ex. B9 | B9 | 6.1 | 0.985 | 0.027 | 0.54 | 5 | 0.01 | 15 | 30 |
| Ex. B10 | B1 | 6.1 | 0.985 | 0.027 | 0.55 | 5 | 0.1 | 15 | 30 |
| Ex. B11 | B1 | 6.1 | 0.985 | 0.027 | 0.55 | 5 | 0.001 | 15 | 30 |
| Ex. B12 | B1 | 6.1 | 0.985 | 0.027 | 0.55 | 5 | 0.008 | 15 | 30 |
| Ex. B13 | B1 | 6.1 | 0.985 | 0.027 | 0.55 | 2 | 0.01 | 15 | 30 |
| Ex. B14 | B1 | 6.1 | 0.985 | 0.027 | 0.55 | 10 | 0.01 | 15 | 30 |
| Ex. B15 | B1 | 6.1 | 0.985 | 0.027 | 0.55 | 5 | 0.01 | 20 | 50 |
| Ex. B16 | B1 | 6.1 | 0.985 | 0.027 | 0.55 | 5 | 0.01 | 10 | 20 |

TABLE 5

| | | | | | | SCP | | Press | Press |
|---|---|---|---|---|---|---|---|---|---|
| | Toner | Particle | Degree of | SD | | Particle | Amount of | contact | contact |
| | particle | size | roundness | value | D/d50 | size | addition | angle | force |
| Com. Ex. B1 | B10 | 7.3 | 0.988 | 0.047 | 0.54 | 5 | 0.01 | 15 | 30 |
| Com. Ex. B2 | B11 | 6.1 | 0.955 | 0.031 | 0.035 | 5 | 0.01 | 15 | 30 |
| Com. Ex. B3 | B12 | 7.0 | 0.945 | 0.029 | 0.038 | 5 | 0.01 | 15 | 30 |
| Com. Ex. B4 | B1 | 6.1 | 0.985 | 0.027 | 0.55 | 1 | 0.01 | 15 | 30 |
| Com. Ex. B5 | B1 | 6.1 | 0.985 | 0.027 | 0.55 | 15 | 0.01 | 15 | 30 |
| Com. Ex. B6 | B1 | 6.1 | 0.985 | 0.027 | 0.55 | 5 | 0.15 | 15 | 30 |
| Com. Ex. B7 | B1 | 6.1 | 0.985 | 0.027 | 0.55 | 5 | 0.01 | 21 | 30 |
| Com. Ex. B8 | B1 | 6.1 | 0.985 | 0.027 | 0.55 | 5 | 0.01 | 9 | 30 |
| Com. Ex. B9 | B1 | 6.1 | 0.985 | 0.027 | 0.55 | 5 | 0.01 | 15 | 51 |
| Com. Ex. B10 | B1 | 6.1 | 0.985 | 0.027 | 0.55 | 5 | 0.01 | 15 | 19 |
| Com. Ex. B11 | B1 | 6.1 | 0.985 | 0.027 | 0.55 | — | no addition | 15 | 30 |

The resulting toner was loaded to a full-color printer (magicolor 2200; made by Minolta Co., Ltd.) that had been set to cleaning conditions (press-contact angle and press-contact force) described in the above-mentioned Tables, and evaluated with respect to the following items. This printer has a structure as shown in FIG. 2, and all the cleaning blades were set to cleaning conditions described in the Tables. In the evaluation in each of the examples and comparative examples, one kind of toner was loaded into all the four developing devices.

(Fogging on Photosensitive Member)

Continuous printing operations for 7,000 copies were conducted on an image having a C/W ratio of 20%, and fogging on a photosensitive member was visually observed. The C/W ratio refers to an area rate of the image portion with respect to the non-image portion.

∘: No fogging occurred;

Δ: Although fogging occurred slightly, no problems were raised in practical use; and

X: Fogging occurred, causing problems in practical use.

(Surface Abrasion of Photosensitive Member)

Continuous printing operations for 7,000 copies were conducted on an image having a C/W ratio of 20%. The film thickness of a photosensitive member layer was measured before and after the continuous printing operations by using an eddy-current-type film-thickness measuring device (HELMUT FISCHER made by Fischer Co., Ltd.), and the amount of abrasion per 100,000 revolutions of the photosensitive member was calculated and evaluated. Scratches on the surface of the photosensitive member after the continuous printing operations were also visually observed and evaluated.

∘: Amount of abrasion was less than 5 μm, without causing any scratches;

Δ: Amount of abrasion was less than 5 μm with slight scratches; however, no problems were raised in practical use; and

X: Amount of abrasion was not less than 5 μm, causing scratches and the subsequent problems in practical use.

(Unswept Toner)

After continuous printing operations for 7,000 copies had been conducted on an image having a C/W ratio of 20%, the degree of unswept toner on each of leading solid images was observed.

∘: No unswept toner occurred;

Δ: Although unswept toner occurred slightly, no problems were raised in practical use; and

X: Unswept toner occurred, causing problems in practical use.

(Lines on Half-Tone Images)

After continuous printing operations for 1,000 copies had been conducted on an image having a C/W ratio of 20% under L/L environment (10° C., 15% RH) and H/H environment (30° C., 85% RH), lines on half-tone images were visually observed.

∘: No lines occurred on half-tone images;

Δ: Although lines slightly occurred on half-tone images, no problems were raised in practical use; and

X: Lines occurred on half-tone images, causing problems in practical use.

(Environmental Stability)

After continuous printing operations for 1,000 copies had been conducted on an image having a C/W ratio of 20% under L/L environment (10° C., 15% RH) and H/H environment (30° C., 85% RH), the image density and fogging on a photosensitive member were visually observed.

∘: Neither degradation in the image density nor fogging occurred;

Δ: Although degradation in the image density and/or fogging slightly occurred, no problems were raised in practical use; and

X: Degradation in the image density and/or fogging slightly occurred, causing problems in practical use.

TABLE 6

| | Fogging on | Abrasion of | | | |
|---|---|---|---|---|---|
| | photosensitive | photosensitive | Unswept | Lines on | Environmental |
| | member | member | toner | Half tone images | stability HH/LL |
| Ex. A1 | ◯ | ◯ | ◯ | ◯ | ◯/◯ |
| Ex. A2 | ◯ | ◯ | ◯ | ◯ | ◯/◯ |
| Ex. A3 | ◯ | ◯ | ◯ | ◯ | ◯/◯ |
| Ex. A4 | ◯ | ◯ | ◯ | ◯ | ◯/◯ |
| Ex. A5 | ◯ | ◯ | ◯ | ◯ | ◯/◯ |
| Ex. A6 | ◯ | ◯ | ◯ | ◯ | ◯/◯ |
| Ex. A7 | ◯ | ◯ | Δ | ◯ | ◯/◯ |
| Ex. A8 | ◯ | ◯ | ◯ | ◯ | ◯/◯ |
| Ex. A9 | ◯ | ◯ | ◯ | ◯ | ◯/◯ |
| Ex. A10 | ◯ | ◯ | ◯ | ◯ | ◯/◯ |
| Ex. A11 | ◯ | ◯ | ◯ | ◯ | ◯/◯ |
| Ex. A12 | ◯ | ◯ | ◯ | ◯ | ◯/◯ |
| Ex. A13 | Δ | ◯ | ◯ | ◯ | Δ/◯ |
| Ex. A14 | ◯ | ◯ | ◯ | Δ | ◯/◯ |
| Ex. A15 | ◯ | ◯ | ◯ | ◯ | ◯/◯ |
| Ex. A16 | ◯ | ◯ | ◯ | ◯ | ◯/◯ |
| Ex. A17 | ◯ | ◯ | ◯ | ◯ | ◯/◯ |
| Ex. A18 | ◯ | Δ | ◯ | Δ | ◯/◯ |
| Ex. A19 | ◯ | ◯ | Δ | ◯ | ◯/◯ |
| Com. Ex. A1 | X | ◯ | ◯ | ◯ | ◯/◯ |
| Com. Ex. A2 | X | ◯ | ◯ | ◯ | ◯/◯ |
| Com. Ex. A3 | X | ◯ | ◯ | ◯ | ◯/◯ |
| Com. Ex. A4 | ◯ | X | X | X | ◯/◯ |
| Com. Ex. A5 | ◯ | ◯ | X | X | ◯/◯ |
| Com. Ex. A6 | ◯ | ◯ | ◯ | ◯ | X/X |
| | | | | | (Lowering of density and |
| | | | | | fogging under H/H and L/L) |
| Com. Ex. A7 | ◯ | X | ◯ | X | ◯/◯ |
| Com. Ex. A8 | ◯ | ◯ | X | ◯ | ◯/◯ |
| Com. Ex. A9 | ◯ | X | ◯ | X | ◯/◯ |
| Com. Ex. A10 | ◯ | ◯ | X | ◯ | ◯/◯ |
| Com. Ex. A11 | ◯ | X | ◯ | X | ◯/◯ |

TABLE 7

| | Fogging on | Abrasion of | | | |
|---|---|---|---|---|---|
| | photosensitive | photosensitive | Unswept | Lines on | Environmental |
| | member | member | toner | Half tone images | stability HH/LL |
| Ex. B1 | ◯ | ◯ | ◯ | ◯ | ◯/◯ |
| Ex. B2 | ◯ | ◯ | ◯ | ◯ | ◯/◯ |
| Ex. B3 | ◯ | ◯ | ◯ | ◯ | ◯/◯ |
| Ex. B4 | ◯ | ◯ | ◯ | ◯ | ◯/◯ |
| Ex. B5 | ◯ | ◯ | ◯ | ◯ | ◯/◯ |
| Ex. B6 | ◯ | ◯ | ◯ | ◯ | ◯/◯ |
| Ex. B7 | ◯ | ◯ | Δ | ◯ | ◯/◯ |
| Ex. B8 | ◯ | ◯ | ◯ | ◯ | ◯/◯ |
| Ex. B9 | ◯ | ◯ | ◯ | ◯ | ◯/◯ |
| Ex. B10 | Δ | ◯ | ◯ | ◯ | Δ/◯ |
| | | | | | (Lowering of density |
| | | | | | under H/H) |
| Ex. B11 | ◯ | ◯ | ◯ | Δ | ◯/◯ |
| Ex. B12 | ◯ | ◯ | ◯ | ◯ | ◯/◯ |
| Ex. B13 | ◯ | ◯ | ◯ | ◯ | ◯/◯ |
| Ex. B14 | ◯ | ◯ | ◯ | ◯ | ◯/◯ |
| Ex. B15 | ◯ | Δ | ◯ | Δ | ◯/◯ |
| Ex. B16 | ◯ | ◯ | Δ | ◯ | ◯/◯ |
| Com. Ex. B1 | X | ◯ | ◯ | ◯ | ◯/◯ |
| Com. Ex. B2 | X | ◯ | ◯ | ◯ | ◯/◯ |
| Com. Ex. B3 | X | ◯ | ◯ | ◯ | ◯/◯ |
| Com. Ex. B4 | ◯ | X | X | X | ◯/◯ |
| Com. Ex. B5 | ◯ | ◯ | X | X | ◯/◯ |
| Com. Ex. B6 | ◯ | ◯ | ◯ | ◯ | X/X |
| | | | | | (Lowering of density and |
| | | | | | fogging under H/H and L/L) |
| Com. Ex. B7 | ◯ | X | ◯ | X | ◯/◯ |
| Com. Ex. B8 | ◯ | ◯ | X | ◯ | ◯/◯ |
| Com. Ex. B9 | ◯ | X | ◯ | X | ◯/◯ |
| Com. Ex. B10 | ◯ | ◯ | X | ◯ | ◯/◯ |
| Com. Ex. B11 | ◯ | X | ◯ | X | ◯/◯ |

With respect to measurements of the glass transition point Tg of resins, a differential scanning calorimeter (DSC-200: made by Seiko Instruments Inc.) was used, while alumina was used as reference, so that 10 mg of a sample was subjected to measurements in the range of 20° C. to 160° C. at a temperature-rise rate of 10° C./min; thus, a shoulder value of the main heat-absorbing peak was obtained as Tg.

With respect to measurements of the softening point Tm of resins, a flow tester (CFT-500: made by Shimadzu Corp.) was used in which: under conditions of a die having a thin pore (diameter: 1 mm, length 1 mm) with an applied pressure of 20 kg/cm² and a temperature-rise rate of 6° C./min, 1 cm³ of the sample was melted and allowed to flow so that the temperature corresponding to ½ of the height from the start point of flowing to the end point of flowing was defined as the softening point.

With respect to the number-average molecular weight and the weight-average molecular weight, measurements were made by using a gel permeation chromatography (807-IT Type: Nippon Bunko Kogyo K.K.) in which: 10 kg/cm³ of tetrahydrofuran was used as a carrier solvent while the column was maintained at 40° C., and 30 mg of a sample to be measured was dissolved in 20 ml of tetrahydrofuran, and 0.5 mg of this solution was then introduced together with the carrier solvent; thus these molecular weights were measured based upon polystyrene conversion.

(Effect of the Present Invention)

When used in an image-forming method under specific cleaning blade conditions, the non-magnetic mono-component of the present invention makes it possible to form superior images that are free from noise such as fogging, lines and unswept toner for a long period of time, while preventing chipping (chipped portions) of the cleaning blade and abrasion in the photosensitive member, and also to provide superior cleaning property, charging property, environmental stability and durability, even in the case when the toner particles have a spherical shape with a small particle size.

What is claimed is:

1. A toner for developing electrostatic latent images, having:
a volume-average particle size of 3 to 7 μm,
an average degree of roundness of 0.960 to 0.995,
a standard deviation of the degree of roundness of not more than 0.04, and
surface properties D/d₅₀ that satisfy the following conditional expression,
wherein 0.001 to 0.1% by weight of fatty acid metal salt that has a volume-average particle size of 1.5 to 12 μm is externally added;
D/d₅₀≧0.40
in which D=6/(ρ·S), (ρ is a true density (g/cm³) of toner particles, S is a BET specific surface area (m²/g) of toner particles), and d₅₀ represents a weight-average particle size (μm) of the toner particles.

2. The toner of claim 1, wherein the fatty-acid metal salt is calcium stearate.

3. The toner of claim 1, which is applied to an image-forming method in which residual toner on an electrostatic latent image supporting member is cleaned by using a cleaning blade.

4. The toner of claim 3, wherein the cleaning blade is placed with a press-contact angle of 10 to 20° and a press-contact force of 20 to 50 N/m with respect to the electrostatic latent image supporting member.

5. The toner of claim 3, wherein the image-forming method is characterized in that an amount of the toner that is transported by a toner-supporting member is regulated by a regulating member that is placed in contact with the surface of the toner supporting member and the regulated toner is transported to a developing area to develop electrostatic latent images.

6. The toner of claim 1, comprising a binder resin having:
a glass transition temperature of 50 to 75° C.,
a softening point of 80 to 160° C.,
a number-average molecular weight of 1,000 to 30,000 and
a ratio of weight-average molecular weight/number-average molecular weight of 2 to 100.

7. The toner of claim 1, comprising a binder resin having:
a glass transition temperature of 50 to 75° C.,
a softening point of 80 to 120° C.,
a number-average molecular weight of 2,500 to 30,000 and
a ratio of weight-average molecular weight/number-average molecular weight of 2 to 20.

8. The toner of claim 1, wherein the toner is prepared by a wet method and subjected to a heat treatment to have a globular shape.

9. The toner of claim 8, wherein the heat treatment is an instantaneous heat treatment by applying heat to toner particles in hot air flow.

10. The toner of claim 1, wherein the toner is prepared by a wet method.

11. The toner of claim 1, wherein the toner is a non-magnetic toner.

12. An image-forming method, in which an electrostatic latent image formed on the surface of an electrostatic latent image supporting member is developed by a toner to form an image; and after the image has been transferred onto a transferring member, the residual toner on the electrostatic latent image supporting member is cleaned by using a cleaning blade, being characterized in that:
the toner has a volume-average particle size of 3 to 7 μm, an average degree of roundness of 0.960 to 0.995,
a standard deviation of the degree of roundness of not more than 0.04, and surface properties D/d₅₀ that satisfy the following conditional expression;
and that 0.001 to 0.1% by weight of fatty acid metal salt that has a volume-average particle size of 1.5. to 12 μm is externally added:
D/d₅₀≧0.40
in which D=6/(ρ·S) (ρ is a true density (g/cm³) of toner particles, S is a BET specific surface area (m²/g) of toner particles), and d₅₀ represents a weight-average particle size (μm) of the toner particles.

13. The method of claim 12, wherein the fatty-acid metal salt is calcium stearate.

14. The method of claim 12, wherein the cleaning blade is placed with a press-contact angle of 10 to 200 and a press-contact force of 20 to 50 N/m with respect to the electrostatic latent image supporting member.

15. The method of claim 12, wherein an amount of the toner that is transported by a toner-supporting member is regulated by a regulating member that is placed in contact with the surface of the toner supporting member and the regulated toner is transported to a developing area to develop electrostatic latent images.

16. The method of claim 12, wherein the toner comprises a binder resin having:
a glass transition temperature of 50 to 75° C.,
a softening point of 80 to 160° C.,
a number-average molecular weight of 1,000 to 30,000 and
a ratio of weight-average molecular weight/number-average molecular weight of 2 to 100.

17. The method of claim 12, wherein the toner comprises a binder resin having:
a glass transition temperature of 50 to 75° C.,
a softening point of 80 to 120° C.,
a number-average molecular weight of 2,500 to 30,000 and
a ratio of weight-average molecular weight/number-average molecular weight of 2 to 20.

18. The method of claim 12, wherein the toner is prepared by a wet method and subjected to a heat treatment to have a globular shape.

19. The method of claim 18, wherein the heat treatment is an instantaneous heat treatment by applying heat to toner particles in hot air flow.

20. The method of claim 12, wherein the toner is a non-magnetic toner.
